(19) United States
(12) Patent Application Publication
(10) Pub. No.: US 2002/0029176 A1
(43) Pub. Date: Mar. 7, 2002

(54) Inventory management system and method

(76) Inventors: Anne Carlson, Berkeley, CA (US); Trip Hosley, San Francisco, CA (US); Bryan Boettger, San Francisco, CA (US); Patty Dennis, Los Angeles, CA (US); Dwight Bayley, Corte Madera, CA (US); Christoph Khouri, San Francisco, CA (US); Christina Tran, San Francisco, CA (US)

Correspondence Address: Pillsbury Winthrop LLP, Intellectual Property Group, 50 Fremont Street, San Francisco, CA, 94105, US

(21) Appl. No.: 09/838,007

(22) Filed: Apr. 13, 2001

Related U.S. Application Data
(60) Provisional application No. 60/230,059, filed on Sep. 1, 2000.

(51) Int. Cl. G06F 17/60

(52) U.S. Cl. 705/28

(57) ABSTRACT

Systems and Methods for tracking and managing an inventory of consumable products. A system in accordance with the present invention comprises a setup unit, a tracking unit and a reporting unit, and preferably has a database for storing data and is an interactive system accessible via the Internet. The system is used preferably in conjunction with a data collection device capable of reading and storing product bar codes, and transferring data to and receiving data from the main system. A method in accordance with the present invention comprises using the data collection device to read the product bar code of each consumed product unit into the system.

### CROSS-REFERENCE TO RELATED APPLICATIONS

This application claims the benefit of U.S. Provisional Application No. 60/230059 filed Sep. 1, 2000.

### FIELD OF THE INVENTION

This invention relates generally to systems and methods for managing an inventory and, more particularly, to systems and methods for tracking and managing an inventory of consumable products.

### BACKGROUND OF THE INVENTION

On-premise operators need to interact and do business with a complex array of suppliers, wholesalers, advertisers, and entertainers, as well as recruit and train employees, and make effective use of various business services, industry news, and modern approaches to marketing. All these interactions and communication challenges are critical for business success, all are time-consuming, and many of them involve dealing with a habitual subset of an actually larger available set of options.

As clear as the need for a modernization of on-premise business communications may be, various aspects of the on-premise business have stood in the way. On-premise businesses tend to be highly traditional, doing things today the ways in which they always have, and they have not been quick to take to new communication technologies. Beyond tradition, there are other business facts of life at work. On-premise operations tend to be small and owner-operated, isolated from one another in any operational sense with huge operational variations from outlet to outlet. A factor compounding the operational individuality is that even with the entry of modern communication technologies in the form of point-of-sale devices, a sweeping standardization of devices has not occurred, and as a result, an array of POS devices are in use. Thus, as a result of individual on-premise businesses being small, and for being collectively fragmented and unable to combine resources, the resources and skills required to develop or invest in an On-premise-appropriate information-bearing network with high upfront fixed costs have not developed.

Timely product consumption data, in particular, are very valuable to participants at each level in a consumer market stream, including manufacturers, distributors, and owners of a retail outlets. Data are useful toward numerous ends, including short term inventory tracking, longer range analysis of trends, and analysis of consumer responses to promotional campaigns and related events. The value of such data is compounded if it is high resolution in terms of being attached to geographical and calendar points, and can be processed in a database that collects data from many outlets, and if it can be integrated with data from other consumer markets.

The liquor and spirits industry is an example of a retail operation where high-resolution end-point consumption data are difficult to obtain. Transactions are often cash, and the distribution of liquor into consumed drinks is simply not quantifiable with any resolution because of individuality in operations and drink definitions. A long-standing traditional method of tracking consumed product is to conduct an inventory of consumed product at the end of each business night which consists of gathering empty bottles and tossing them individually into a trash receptacle and breaking them, whilst making a mark on an inventory list, bottle-by-bottle. The list which is produced every night is thus called a “breaksheet”, and it is a highly accurate volume-based accounting of consumed product, which is uncomplicated by the various forms in which the product is actually consumed. The short-coming of this type of data collection is that it generally is not translated into digital form, and is not transmissable to a database where it can be processed into more meaningful information.

Thus, there exists a need within the on-premise industry to modernize data collection and to integrate it into a unified form of business and marketing service. Of all forms of informational input into the system, the most central would be highly accurate, high resolution consumption data. Critical to the success of obtaining these data and building a system around it would be the acceptability and ripple-free entry of such an inventory tracking system into the existing traditional business environment within the on-premise industry.

### SUMMARY OF THE INVENTION

The present invention provides systems and methods for tracking and managing an inventory of consumable products. A system in accordance with the present invention comprises a setup unit, a tracking unit and a reporting unit. Preferably, the system has a database for storing data and is an interactive system accessible via the Internet. In addition, the system is used preferably in conjunction with a data collection device capable of scanning and storing UPC bar codes, and transferring data to and receiving data from the main system.

In a preferred embodiment, a user utilizes the setup function of the system in conjunction with an inventory data collection device to set up and store in the system database a profile of inventory information for various inventory points throughout the user's retail store, bar, nightclub or restaurant (hereinafter collectively referred to as “venue”). The inventory information preferably includes information for all the distributors the user utilizes for delivery of his products (e.g. contact information, order days, delivery days, etc.), the type of inventory points (e.g., storage point or order point), inventory data (e.g., number and type of products at each inventory point), and par level (i.e., optimal inventory level) for each of the products. Preferably, the distributor information, the type of inventory points, and the par level for each of the user's products are directly input into the system via an electronic data transfer such as a data transfer via the Internet, which are modifiable at any time, and subsequently downloaded to the data collection device. The data collection device is preferably used to collect inventory data and upload the collected data to the system database.

Similarly, the user utilizes the tracking function of the system in conjunction with a consumption data collection device, which is preferably the same device as the inventory data collection device mentioned above. Preferably, the data collection device is used to collect data regarding consumed products (e.g., the number of consumed products and the frequency of consumption at each and every order point) by scanning and storing the UPC bar code of the empty packages of the consumed products. With the consumption data periodically uploaded to the main system, the system is capable of offering a suggested order amount and distributor for a product; changing, confirming, making and printing product orders; and changing and confirming distributors; and tracking and managing product inventory. Other tracking functions of the system include providing data transfer history; viewing, modifying, confirming and printing suggested distributor orders and order amounts; adding distributors and inventory points; and adjusting inventory and par levels.

Furthermore, the system allows the user to view and print various reports, including a current inventory report, an inventory adjustment report and a product consumption report.

### BRIEF DESCRIPTION OF THE FIGURES

FIG. 1 is a functional page flow for an inventory management system in accordance with the present invention.

FIG. 2 is a wireframe for a web page of an inventory management system in accordance with the present invention.

FIG. 3 is a wireframe for a web page of an inventory management system in accordance with the present invention.

FIG. 4 is a wireframe for a web page of an inventory management system in accordance with the present invention.

FIG. 5 is a wireframe for a web page of an inventory management system in accordance with the present invention.

FIG. 6 is a wireframe for a web page of an inventory management system in accordance with the present invention.

FIG. 7 is a wireframe for a web page of an inventory management system in accordance with the present invention.

FIG. 8 is a wireframe for a web page of an inventory management system in accordance with the present invention.

FIG. 9 is a wireframe for a web page of an inventory management system in accordance with the present invention.

FIG. 10 is a wireframe for a web page of an inventory management system in accordance with the present invention.

FIG. 11 is a wireframe for a web page of an inventory management system in accordance with the present invention.

FIG. 12 is a wireframe for a web page of an inventory management system in accordance with the present invention.

FIG. 13 is a wireframe for a web page of an inventory management system in accordance with the present invention.

FIG. 14 is a wireframe for a web page of an inventory management system in accordance with the present invention.

FIG. 15 is a wireframe for a web page of an inventory management system in accordance with the present invention.

FIG. 16 is a wireframe for a web page of an inventory management system in accordance with the present invention.

FIG. 17 is a wireframe for a web page of an inventory management system in accordance with the present invention.

FIG. 18 is a wireframe for a web page of an inventory management system in accordance with the present invention.

FIG. 19 is a wireframe for a web page of an inventory management system in accordance with the present invention.

FIG. 20 is a wireframe for a web page of an inventory management system in accordance with the present invention.

FIG. 21 is a wireframe for a web page of an inventory management system in accordance with the present invention.

FIG. 22 is a wireframe for a web page of an inventory management system in accordance with the present invention.

FIG. 23 is a wireframe for a web page of an inventory management system in accordance with the present invention.

FIG. 24 is a wireframe for a web page of an inventory management system in accordance with the present invention.

FIG. 25 is a functional page flow for an inventory tracking device in accordance with the present invention.

FIG. 26 is a wireframe for a screen display of an inventory tracking device in accordance with the present invention.

FIG. 27 is a wireframe for a screen display of an inventory tracking device in accordance with the present invention.

FIG. 28 is a wireframe for a screen display of an inventory tracking device in accordance with the present invention.

FIG. 29 is a wireframe for a screen display of an inventory tracking device in accordance with the present invention.

FIG. 30 is a wireframe for a screen display of an inventory tracking device in accordance with the present invention.

FIG. 31 is a wireframe for a screen display of an inventory tracking device in accordance with the present invention.

FIG. 32 is a wireframe for a screen display of an inventory tracking device in accordance with the present invention.

FIG. 33 is a wireframe for a screen display of an inventory tracking device in accordance with the present invention.

FIG. 34 is a wireframe for a screen display of an inventory tracking device in accordance with the present invention.

### DETAILED DESCRIPTION OF THE INVENTION

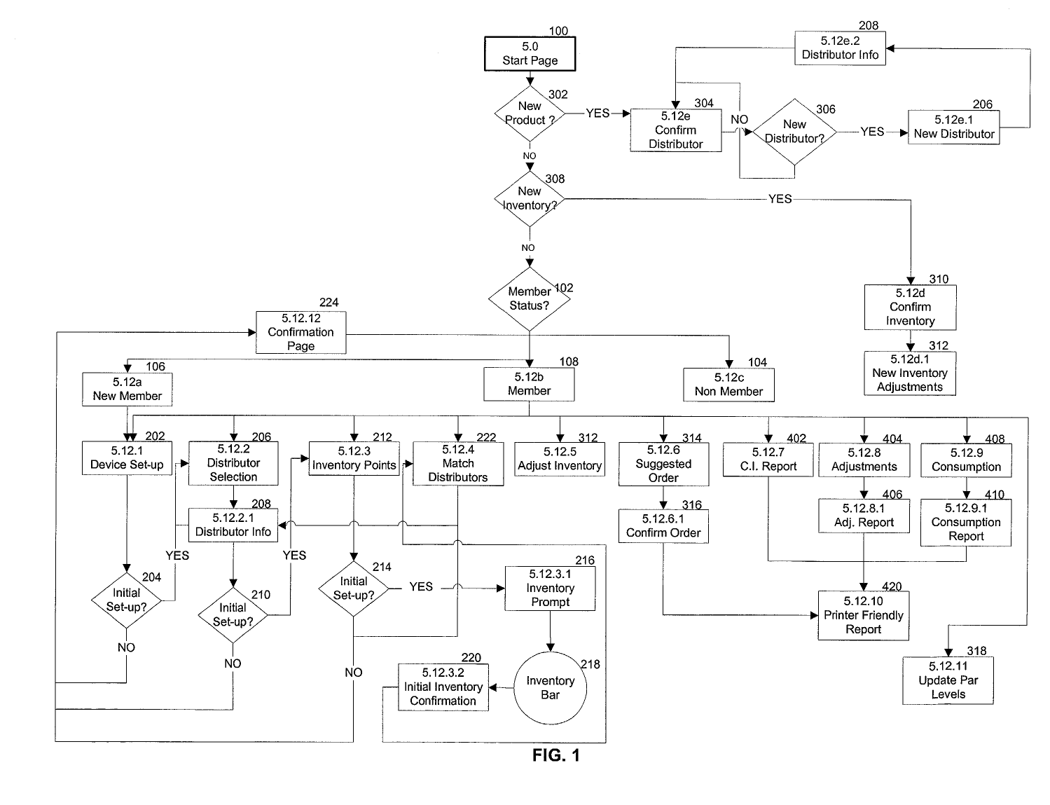

FIG. 1 illustrates the general page flow of an inventory management system in accordance with the present invention. Preferably, the system is an interactive system operable via the Internet and accessible by multiple venue owners at multiple locations. The operation of the system can be separated into three general categories: setup, tracking and reporting, which will be discussed in detail below.

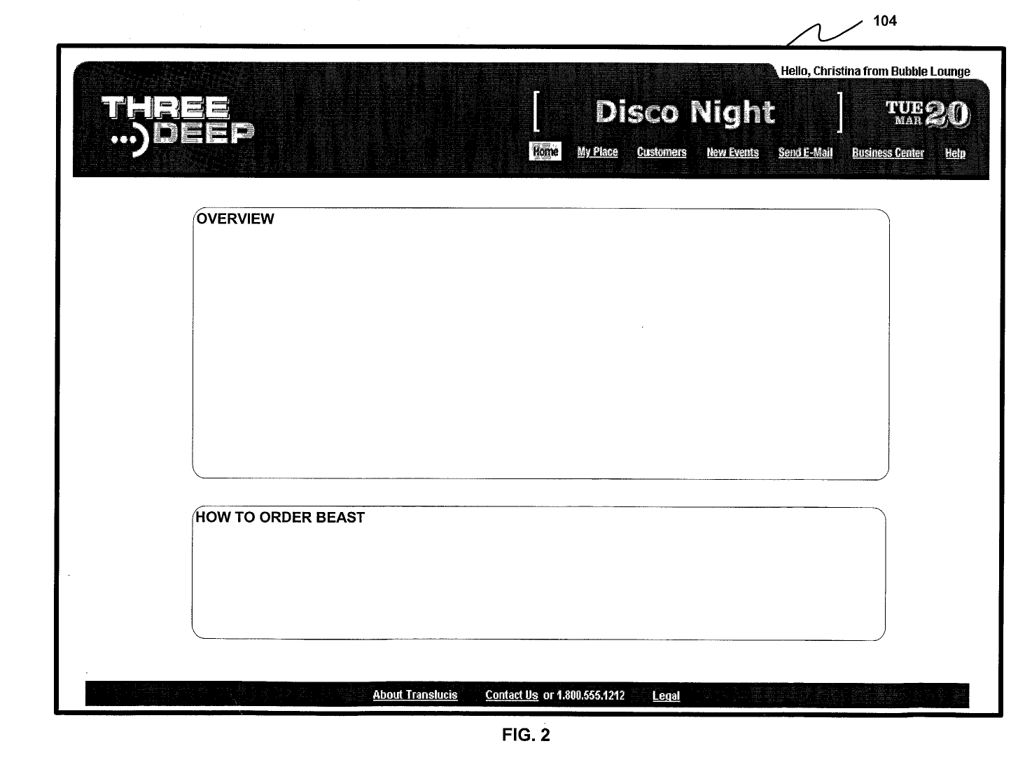

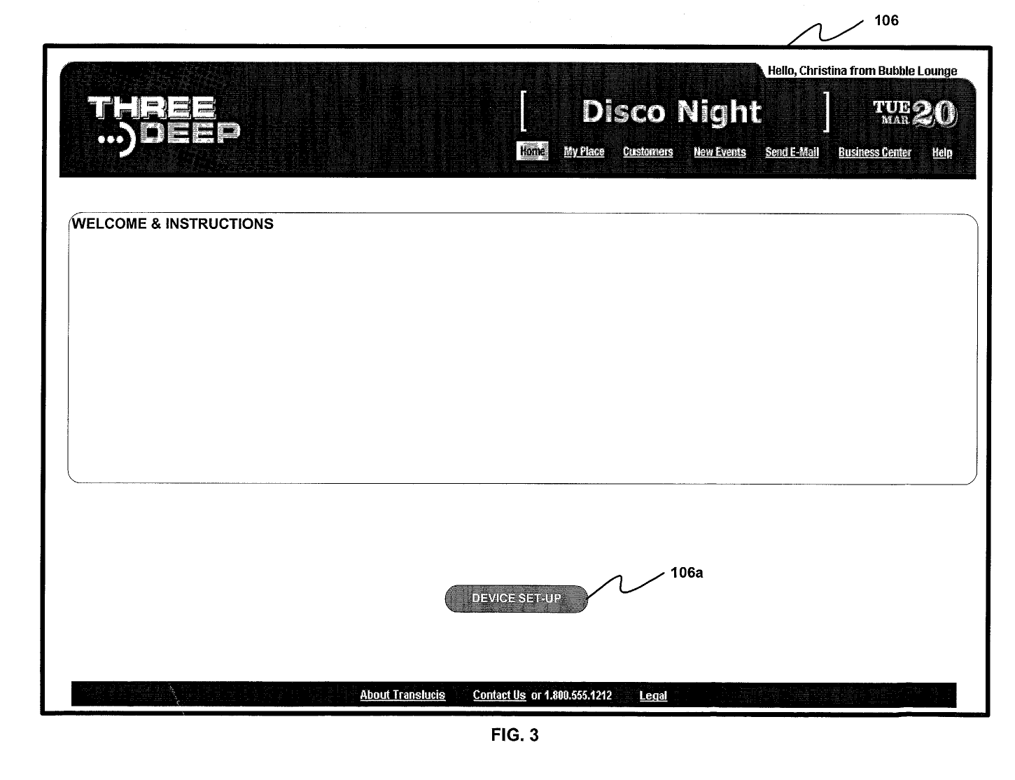

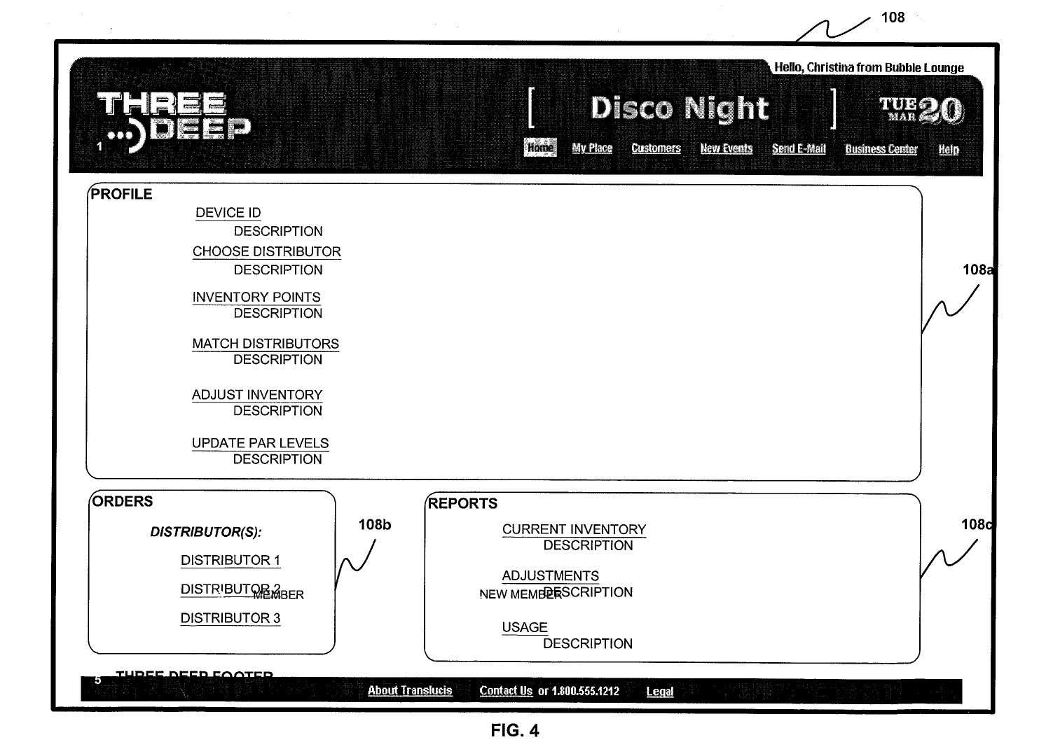

Still referring to FIG. 1, a user of the system first arrives at a Home Page 100 by connecting to the system via the Internet. Home Page 100 allows the user to create a profile for his venue. The user profile includes information regarding the user's venue such as the name and location of the venue, a system login password and/or a user name. Preferably, Home Page 100 also serves as the starting point for services such as email, customer relations, new event announcements, and business center. The user then enters the inventory management system Start Page 101, at which point the system recognizes the user as a new member (i.e., a user who has signed up for but has never used the inventory management system), a member (i.e., a user who has completed the setup process of the inventory management system), or a nonmember (i.e., a user who has not signed up to use the inventory management system). If the user is a nonmember, the system brings him to a Nonmember Page 104, which provides an overview of the system and information on how to order the inventory tracking device (i.e., the “BeaST™ handheld”) used in the system (see FIG. 2), which will be discussed in detail below. If the user is a new member or a member without any new product or new inventory stored in the system's database, the system bypasses decision blocks 302 and 308, which will be revisited and discussed in further detail below. Based on the user profile, therefore, the system brings the user to an appropriate New Member page 106 or Member Page 108, which are shown in FIGS. 3 and 4, respectively.

Turning now to FIGS. 1, 3 and 5, the New Member page 106 (FIG. 3) provides a user with instructions on how to use the system. The user then presses a “device set-up” icon 106a at the bottom of the New Member page 106 with either a mouse or keystrokes to begin the setup process. Note that most web pages in the system, including New Member page 106, contain a menu 700 which provides hyperlinks to other web pages in the system.

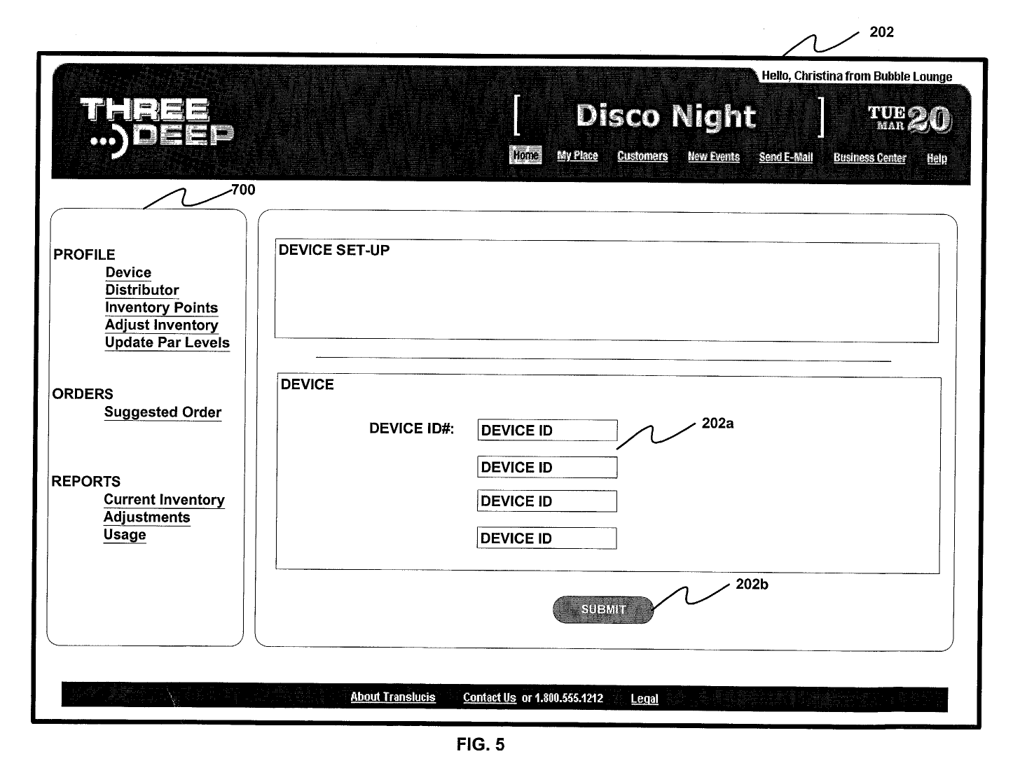

The setup process starts with Device Setup page 202 (FIG. 5). The “device” referred herein is the BeaST™ handheld or a similar inventory tracking device, which will be discussed in detail below. The device setup process comprises entering a device ID in a window 202a for each BeaST™ handheld or similar device used or to be used at the user's venue. After entering the device ID or IDs, the user presses a “submit” icon 202b at the bottom of Device Setup page 202 to complete the device setup process. The user may come back to Device Setup page 202 after the initial setup from any other page to register more devices by choosing the hyperlink “Device” from menu 700 within any other page. After the initial setup, windows 202a will be pre-populated with device IDs for devices already registered, and a new window may be selected for entering a new device ID to register a new device.

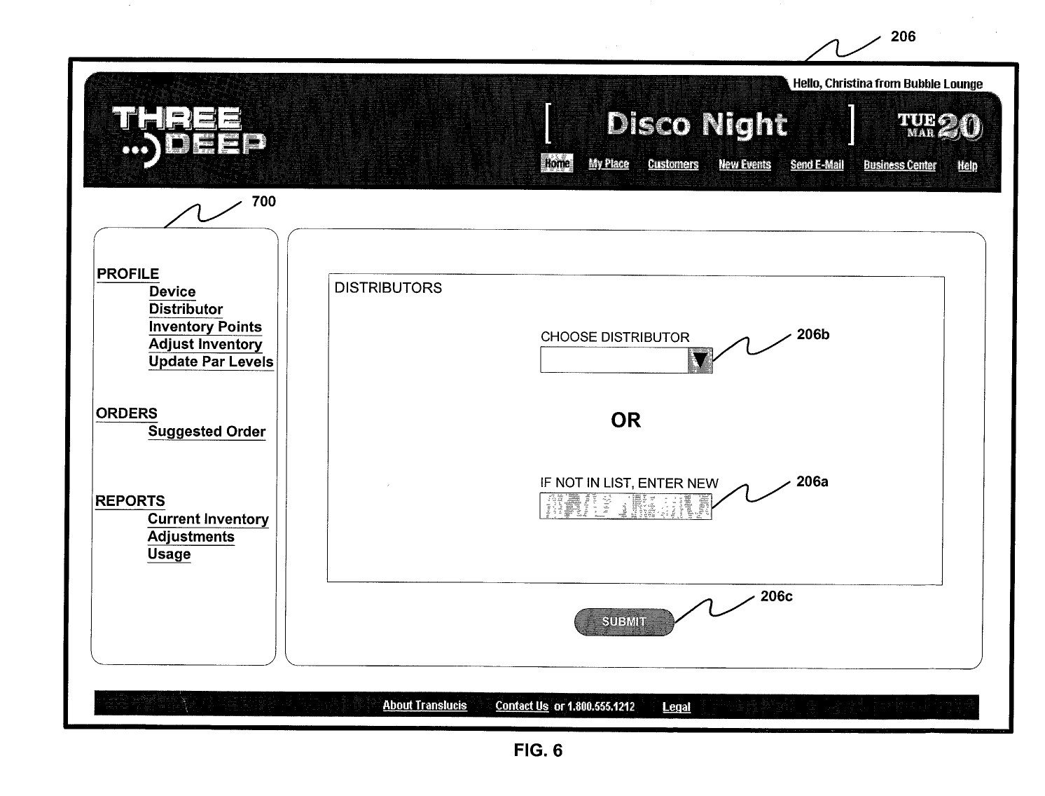

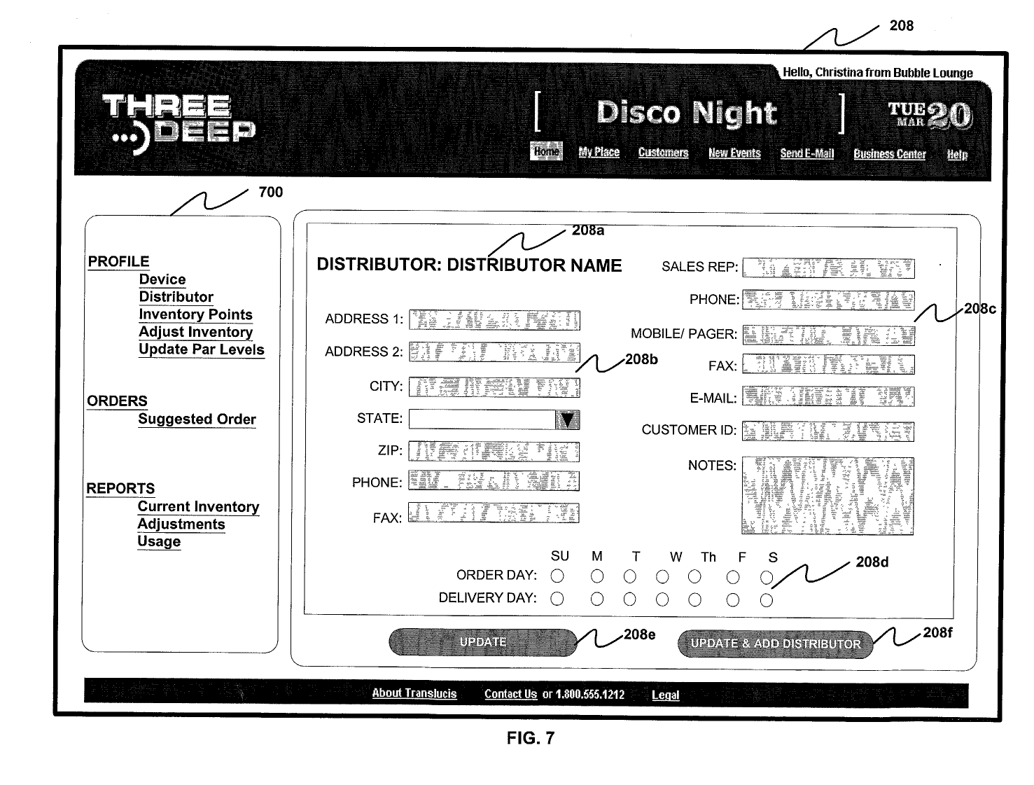

Turning to FIGS. 1, 6 and 7, the system determines whether an initial setup has been completed at decision block 204. If the initial setup has been completed and the user is visiting Device Setup page 202 to register more devices, the system directs the user to Confirmation page 224. If the initial setup has not been completed, the system brings the user to Distributor Selection page 206, which is shown in FIG. 6. At Distributor Selection page 206, the user enters a new distributor in window 206a and press the “submit” icon 206c at the bottom of Distributor Selection page 206. The user is then brought to Distributor Info page 208 (see FIG. 7), where the user enters various information about the distributor entered in window 206a on Distributor Selection page 206. A “Distributor Name” area 208a shows the name of the distributor entered in window 206a. The address and phone number area 208b indicates such particular information of the distributor, and it may be pre-populated if such information is available in the system's database. The user may change any part of the pre-populated information. On the other hand, the contact information 208c must be entered by the user. The user also specifies the order day or days and delivery day or days for the distributor in area 208d. The user may then choose the “update” icon 208e to finish the distributor setup process, or he may choose the “update & add distributor” icon 208f to enter information about another distributor. This completes the distributor setup process. Note that after initial setup, when the user wishes to edit the information for a particular distributor already input in the system, he may choose the distributor in window 206b on Distributor Selection page 206, click on “submit” 206c, and edit the information accordingly on Distributor Info page 208.

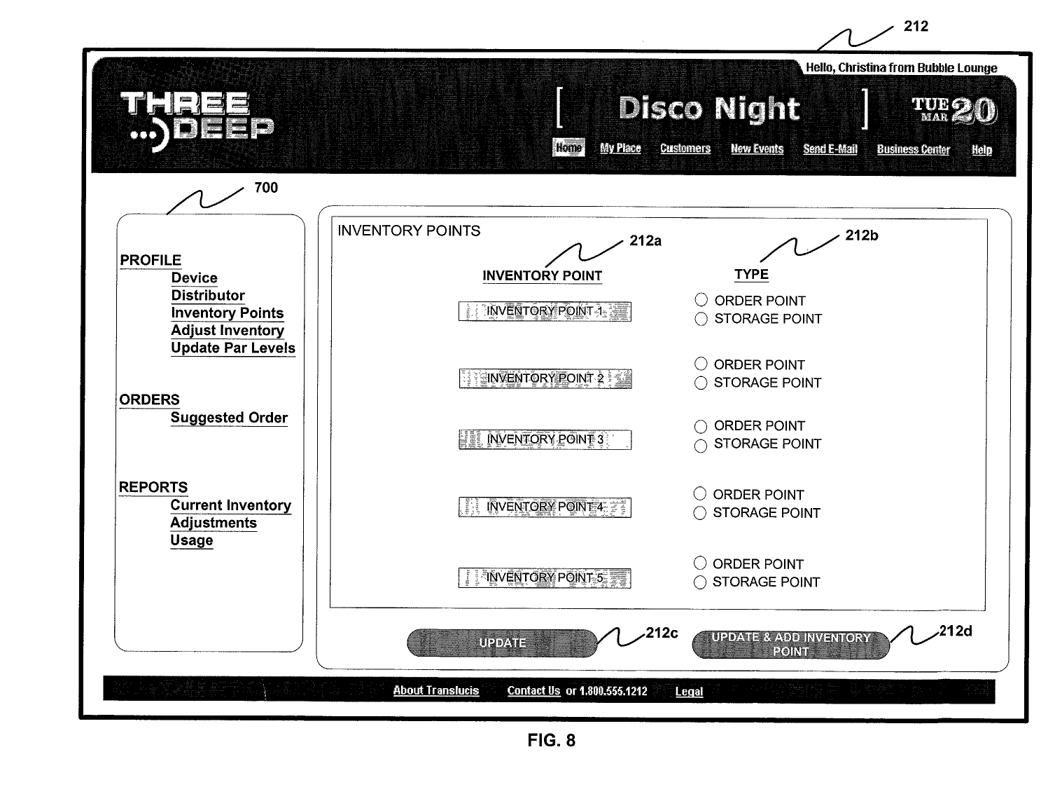

Referring now to FIGS. 1, 8 and 9, the system determines whether an initial setup has been completed at decision block 210. If the initial setup has been completed and the user is visiting Distributor Selection page 206 and Distributor Info 208 to register more distributors or edit the information of a distributor, the system directs the user to Confirmation page 224. If the initial setup has not been completed, the system brings the user to Inventory Points page 212, which is shown in FIG. 8. At Inventory Points page 212, the user inputs the names of different inventory points throughout his venue in area 212a, along with the types of those inventory points (i.e., order point or storage point) in area 212b. The user may then choose “update” 212c to finish the process or he may choose “update & add inventory point” 212d to input more inventory points and their types. If the user is a member and wishes to add new inventory points, he may be brought to Inventory Points page 212 from any other page by clicking on the hyperlink “Inventory Points” in menu 700. In that scenario, areas 212a and 212b may be pre-populated with inventory points and their types already recorded in the system's database.

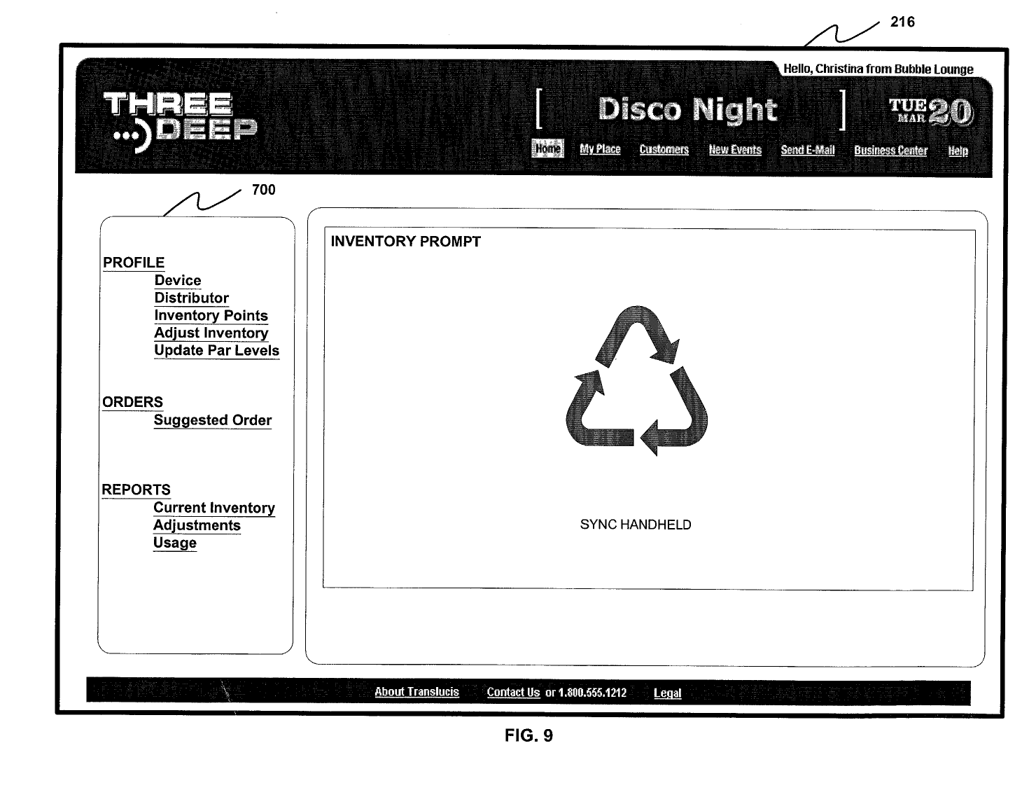

At this point the system again checks to determine if an initial setup has been completed at decision block 214. If the initial setup has been completed, the system directs the user to Confirmation page 224. If the initial setup has not been completed, the system brings the user to Inventory Prompt 216, which is shown in FIG. 9. Inventory Prompt 216 is a prompt to instruct the user to download via an Internet connection (i.e., “sync”) to his BeaST™ handheld or similar device the information he has entered online. After the user syncs his BeaST™ handheld or similar device with the system, the user is ready to take inventory throughout the inventory points at his venue (see Inventory Bar junction 218).

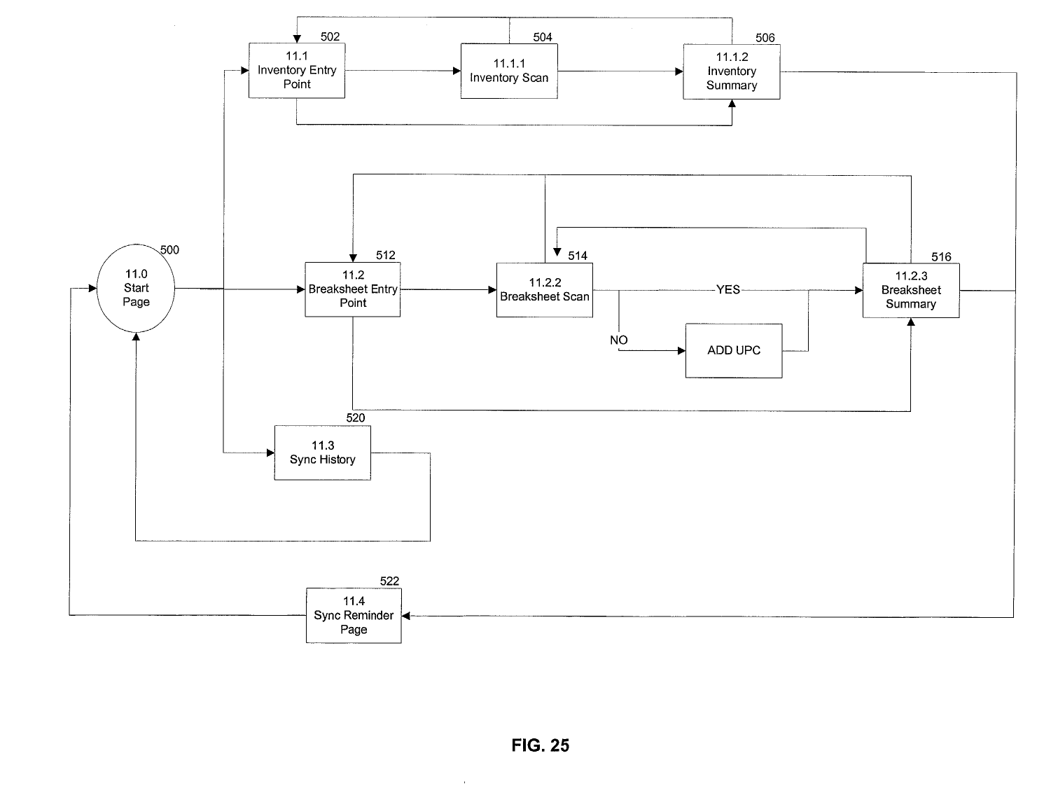

Turning now to FIGS. 25-29, the user begins collecting inventory data with a BeaST™ handheld or similar inventory tracking device in accordance with the present invention. Such a device comprises a scanner, an inventory data collection unit, a consumption data collection unit, and a data transfer unit, which will be discussed in detail below. Preferably, the device is a wireless portable handheld device. More preferably, the device has a pressure-sensitive screen such that an item on the screen may be selected by pressing that area of the screen with a finger or with a pointed object.

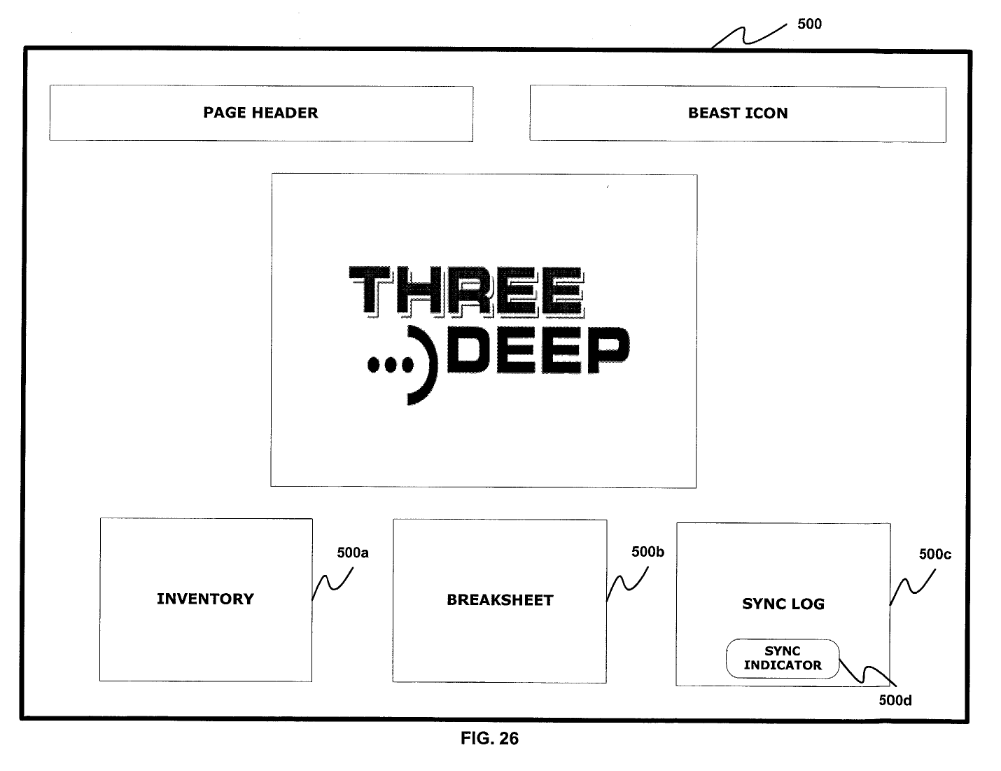

FIG. 25 is a page flow for the operation of a BeaST™ handheld or similar device in accordance with the present invention. At Start Page 500, which is shown in FIG. 26, the user may choose to go into the inventory data collection unit by selecting the “Inventory” icon 500a; or he may choose to go into the consumption data collection unit by selecting the “Breaksheet” icon 500b. In addition, the user may choose to go into the summary section of the data transfer unit by selecting “Sync Log” icon 500c. The “Sync Indicator” 500d informs the user whether there are data in the device to be transferred to the inventory management system. Preferably, Sync Indicator 500d flashes when there are data to be transferred. Alternatively, Sync Indicator 500d can be made to simply light up to indicate the availability of transferable data.

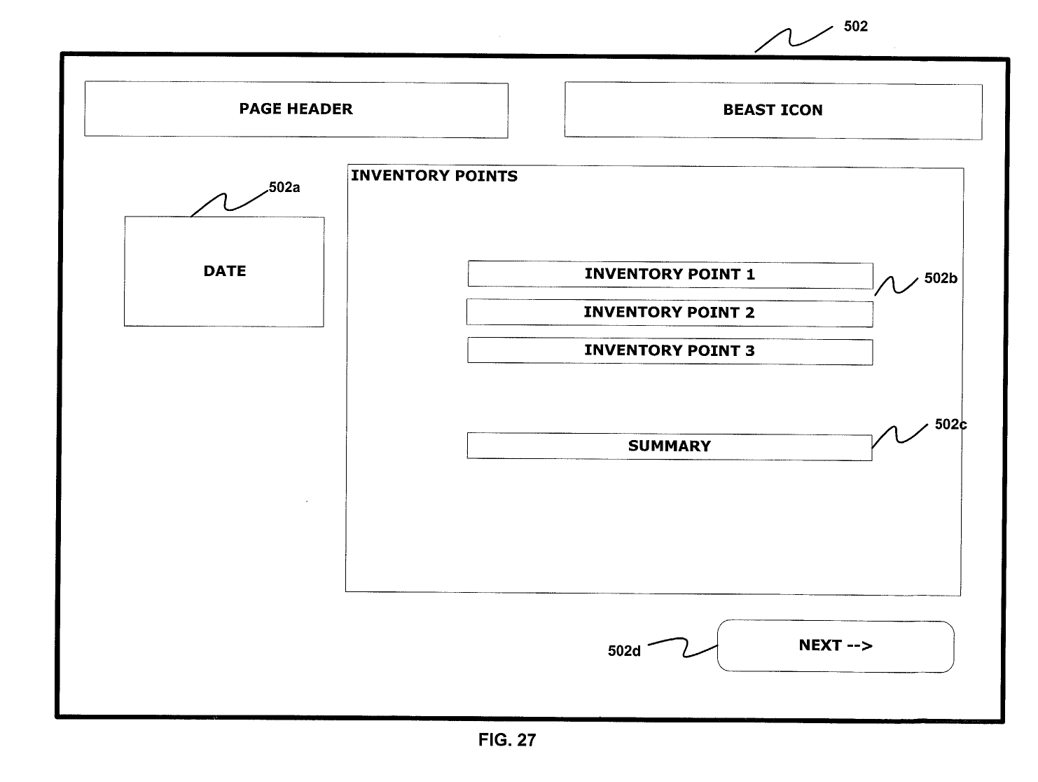

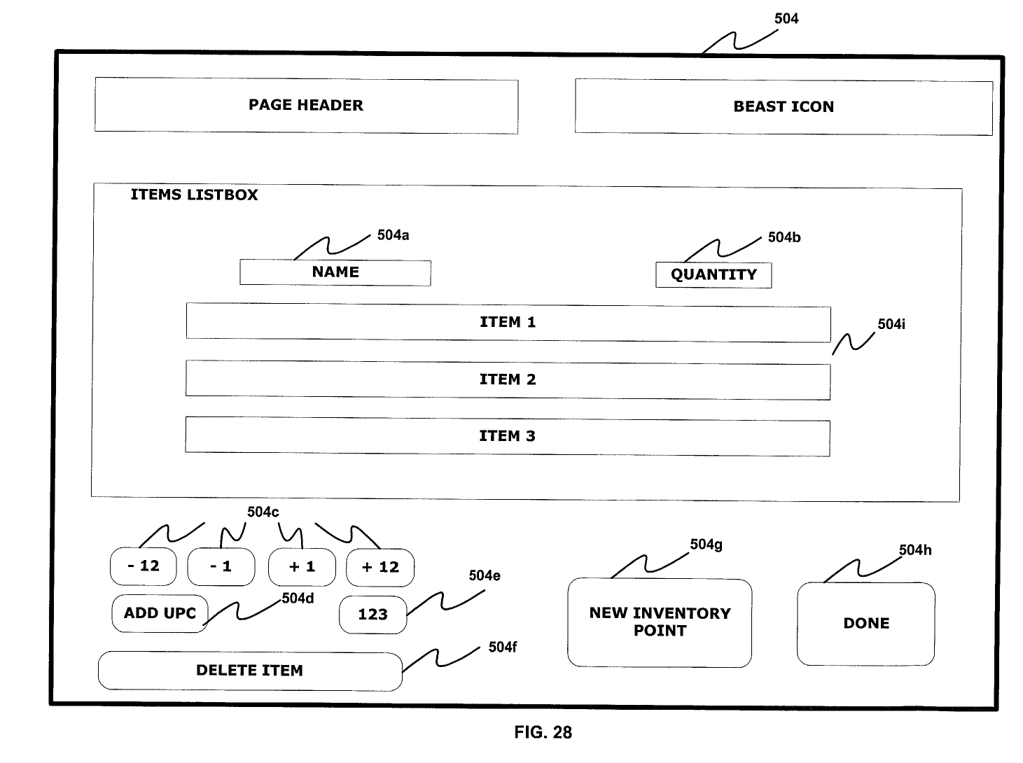

Therefore, when “Inventory” Icon 500a is selected, the device takes the user to an Inventory Entry Point Screen 502 (see FIGS. 1 and 27). The Inventory Entry Point 502 screen comprises a “Date” field 502a, an “Inventory Point” fields 502b, a “Summary” field 502c, and a “Next” icon 502d. Date field 502a is preferably pre-populated with the current date. If the user wishes to change the date on which the inventory takes place, he may select Date field 502a and enter the correct date. Next, the user selects an inventory point in the Inventory Point field 502b and selects the Next icon 502d. This brings the user to Inventory Scan 504 (see FIGS. 1 and 28), a screen where he may collect inventory data. For every type of product at the inventory point selected by the user, he either scans the product's UPC or enters the UPC manually by selecting and pressing the “Add UPC” icon 504d. The user may continue to scan or manually enter the UPC for every occurrence of a particular product, or he may count the number of that product and enter the number manually by selecting and pressing the “123” icon 504e. Preferably, when the UPC of a particular product is scanned or manually entered only once and then the “123” icon is selected, and a number is entered, the device recognizes the number entered as the total number of units for that product. If, however, the UPC of the product is scanned or manually entered more than once, and a number is entered subsequently by selecting the “123” icon 504e, the device adds the number entered to the number of times the UPC has been scanned or manually entered. The device then records the sum of the two numbers as the total number of units for the product. Alternatively, the user may scan or manually enter the UPC, and then add or subtract the number of units by pressing one or more of the add/subtract icons 504c. For example, every time the “+1” icon is pressed, the device adds 1 to the number of units recorded. Because beverages are often packaged in cases of 12, the “+12” icon can be used to add the number of cases of the product to the total number of units for that product. The icons “−1” and “−12” are used similarly for subtracting a single unit or a case of 12 units from the total number of units. As the user collects inventory data, field 504i updates accordingly, with names of products appearing under the “Name” heading 504a and the number of units for the products appearing under the “Quantity” heading 504b. Upon collecting the inventory data for the inventory point selected, the user may choose a new inventory point by pressing the “New Inventory Point” icon 504g and repeat the process until all products have been collected from all inventory points at the venue. The user then chooses the “Done” icon 504h to communicate to the device that all of the inventory data have been collected.

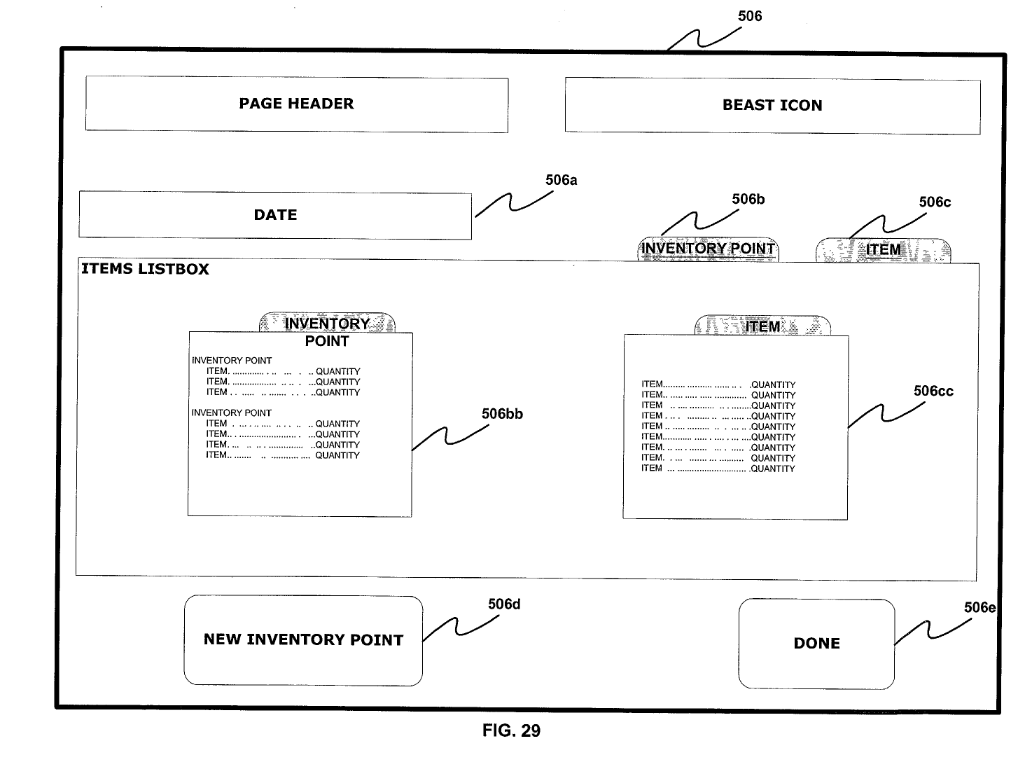

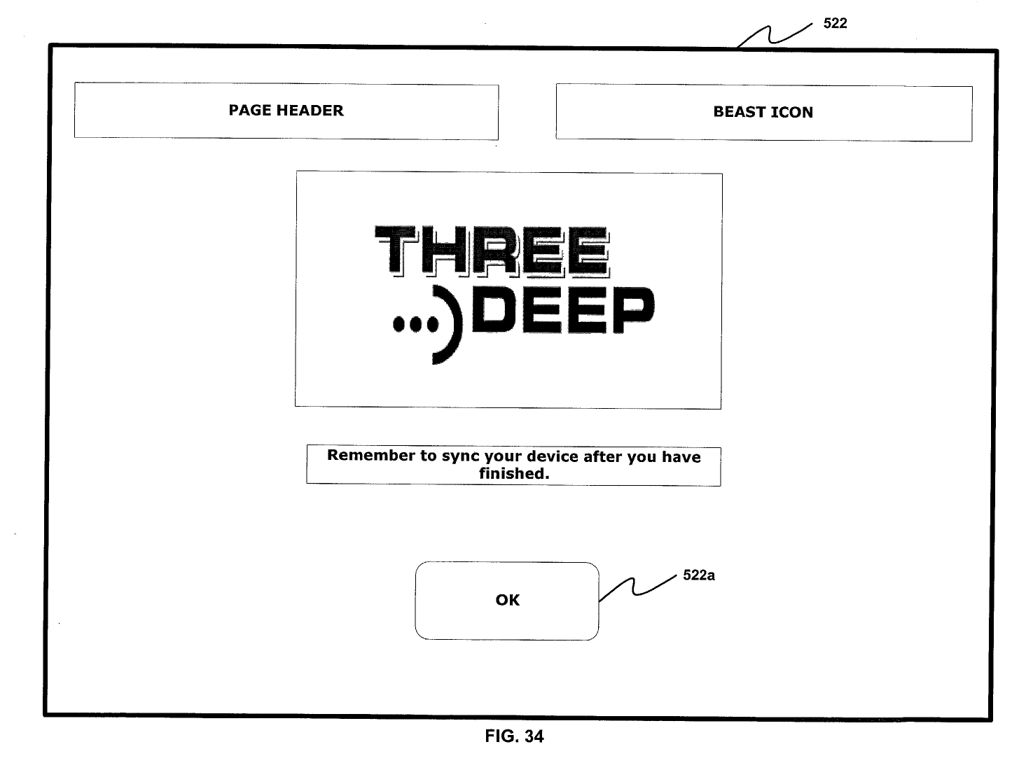

Referring specifically to FIGS. 25, 29 and 34, the user is brought to the Inventory Summary screen 506 when the “Done” icon 504h is selected. Inventory Summary screen 506 includes a “Date” field 506a, an “Inventory Point” tab 516b, which brings the “Inventory Point” sub-screen 506bb to the foreground of the screen, an “Item” tab 506c, which brings the “Item” sub-screen 506cc to the screen foreground, a “New Inventory Point” icon 506d, and a “Done” icon 506e. Note that both sub-screens 506bb and 506cc are shown in the foreground in FIG. 29 for illustration only. Inventory Summary screen 506 provides an inventory summary for a given date so that the user may confirm the inventory data he has collected for that date. The “Date” field 506a is preferably pre-populated with the current date, however, the user may change the date in the field to bring up the inventory summary for any particular date. The “Inventory Point” sub-screen 506bb provides an inventory summary for each and every inventory point throughout the venue. On the other hand, the “Item” sub-screen 506cc provides an inventory summary for the whole entire venue. The user may go back to the Inventory Entry Point screen 502 to collect inventory data for a new inventory point by selecting the “New Inventory Point” icon 506d. Similarly, at any time before, during or after the inventory data collection process, the user may go to the Inventory Summary screen 506 from the Inventory Entry Point screen 502 by selecting the “Summary” icon 502c and then the “Next” icon 502d. Upon confirming at the Inventory Summary screen 506 all the inventory data collected, the user selects the “Done” icon 506e, which brings him to a Sync Reminder Page 522 (see FIG. 34). Sync Reminder Page 522 reminds the user to transfer the inventory data collected with the handheld device to the main system. Once the “OK” icon is selected, the user is brought back to Start Page 500, and he may then sync the handheld device with the main system. As mentioned above, the “Sync Indicator” 500d on the device Start Page 500 would flash to inform the user the availability of transferable data until that data have been transferred.

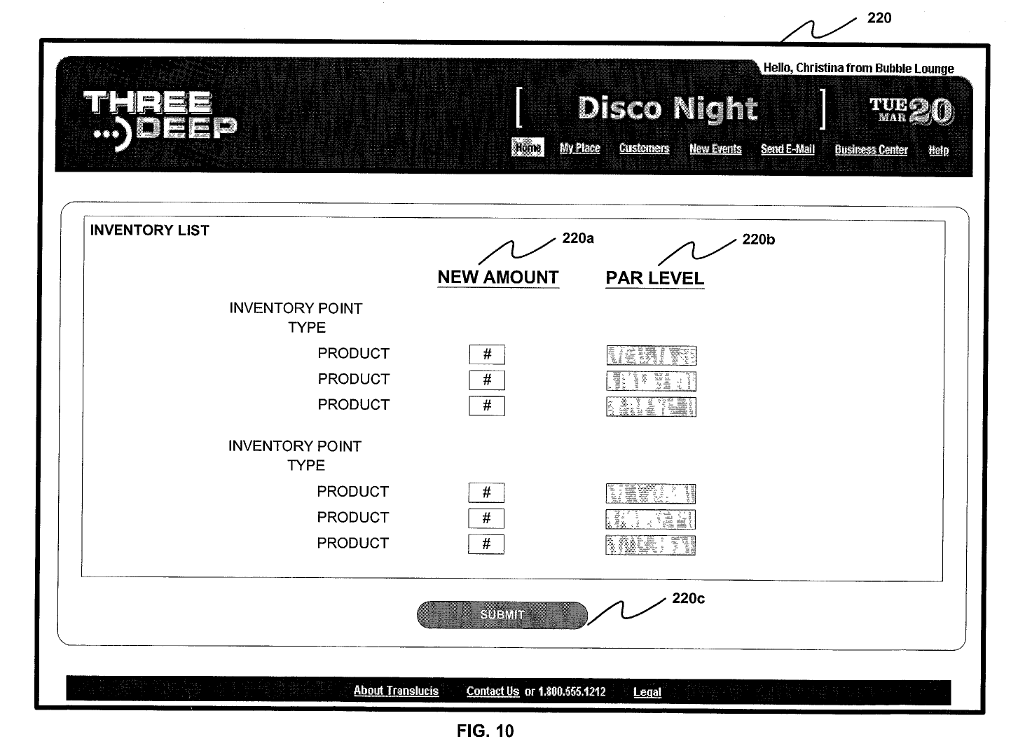

Turning now to FIGS. 1 and 10, the user is brought to the Initial Inventory Confirmation page 220 of the system once the initial inventory data have been collected and transferred to the inventory management system. The Initial Inventory Confirmation page 220 includes a “New Amount” field 220a, a “Par Level” field 220b, and a “Submit” icon 220c. Preferably, the “New Amount” field 220a is pre-populated with the transferred inventory data, which may be modified by the user if any inventory level were inaccurately uploaded from the handheld device. The user then sets a par amounts per product per inventory point in the “Par Level” field 220b. Once both fields 220a and 220b are filled, the user selects the “Submit” icon to store these data in the system database.

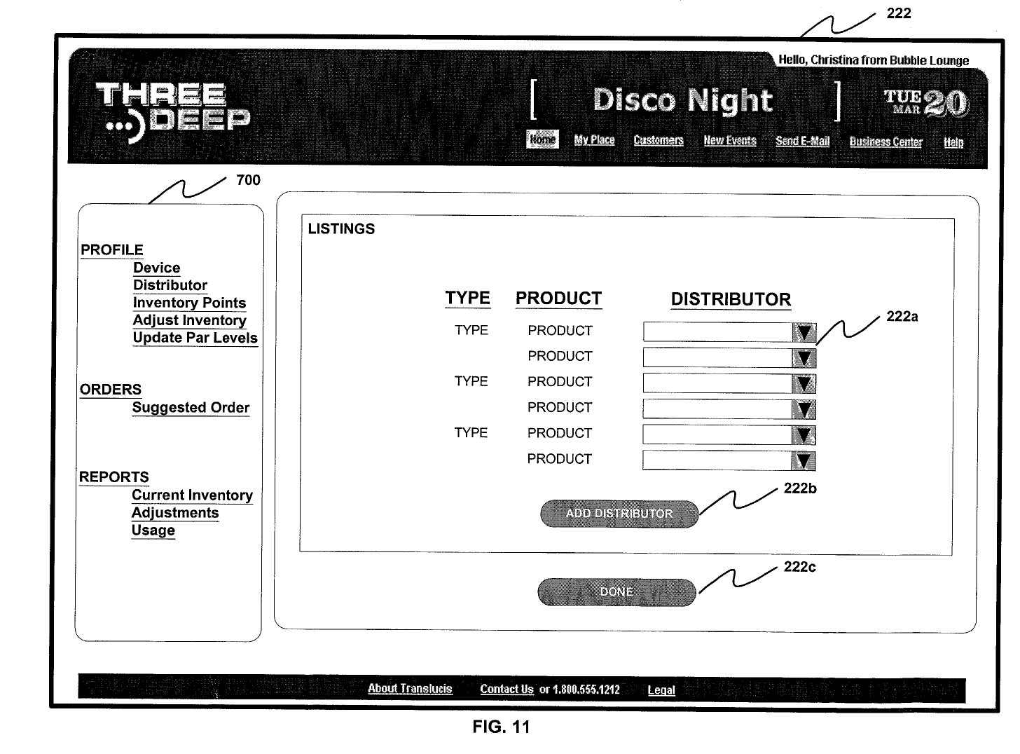

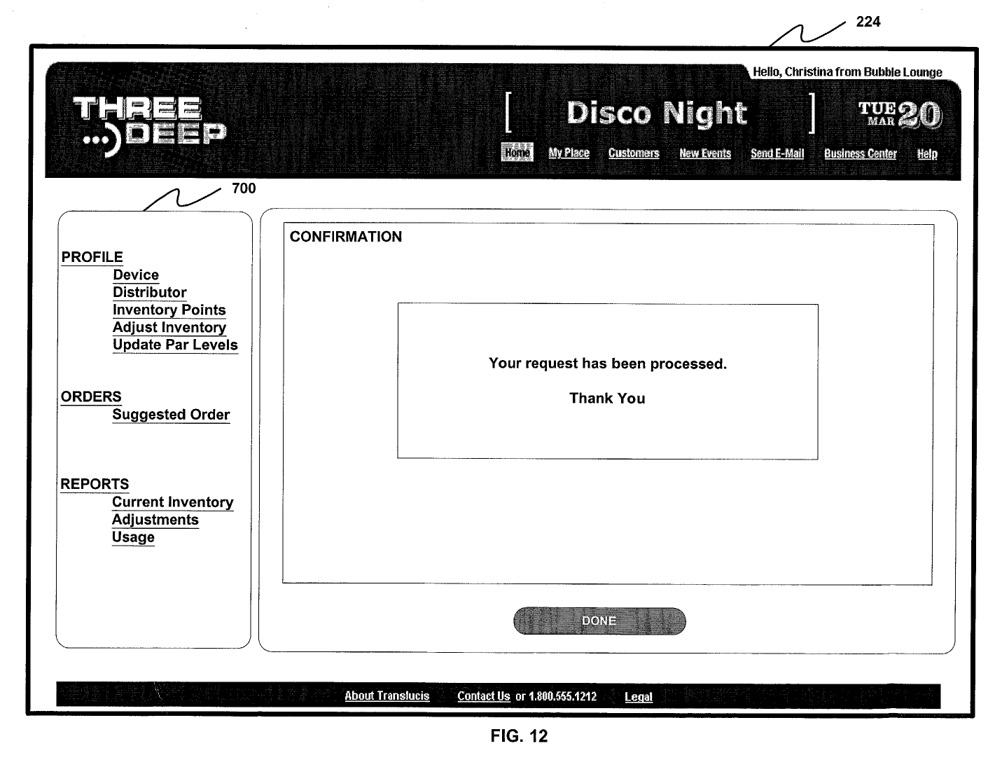

Referring to FIGS. 1, 11 and 12, the user is then brought to a Match Distributors page 222, where the user matches his products to his distributors. The system will offer suggested matches in a “Distributor” field 222a to ease this process and will allow the user to change any suggested matches or to pair any products and distributors where the system is unable to come up with suggested matches. The system offers its suggestion based on the list of distributors the user has entered into the system using the functions of the Distributor Info page 208 and the information it has in its database with respect to these distributors. At any time, the user may press the “Add Distributor” icon 222b to go to the Distributor Info page 208 and add more distributors to his distributor list. Once the user matches his products with distributors, the user has completed the setup process and is brought to a Confirmation Page 224 after the “Done” icon 222c is selected. Confirmation Page 224 basically acknowledges that the user's setup request has been input and processed. In addition to the setup process, the user is also brought to Confirmation Page 224 when he submits other requests such as adjusting inventory, etc., which will be discussed in detail below.

Once the user has completed the setup process, he has achieved member status and may begin using the consumption data collection (i.e., breaksheet) functionality of his BeaST™ handheld or similar device in conjunction with the tracking functions of the inventory management system. The user has incredible flexibility of his breaksheet usage. While the tracking and reporting for the inventory of the user's venue works best when breaksheet is completed everyday, the user has the option to complete breaksheet on any frequency he desires while still being able to utilize the tracking and reporting functionalities.

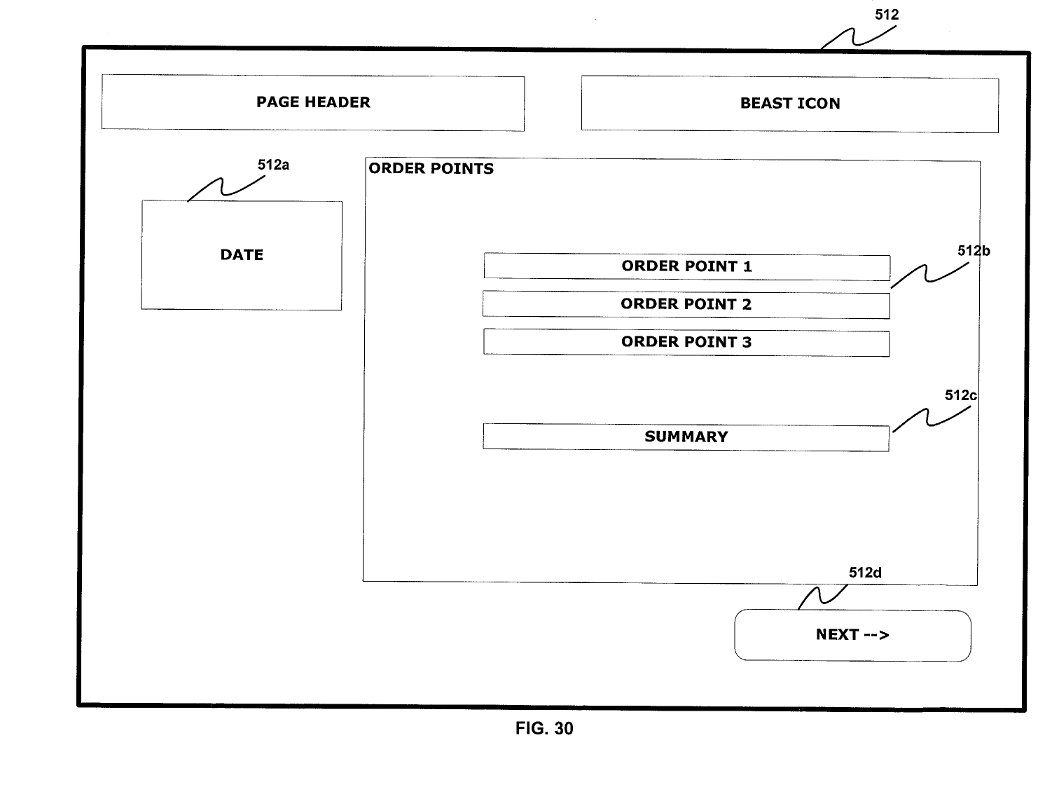

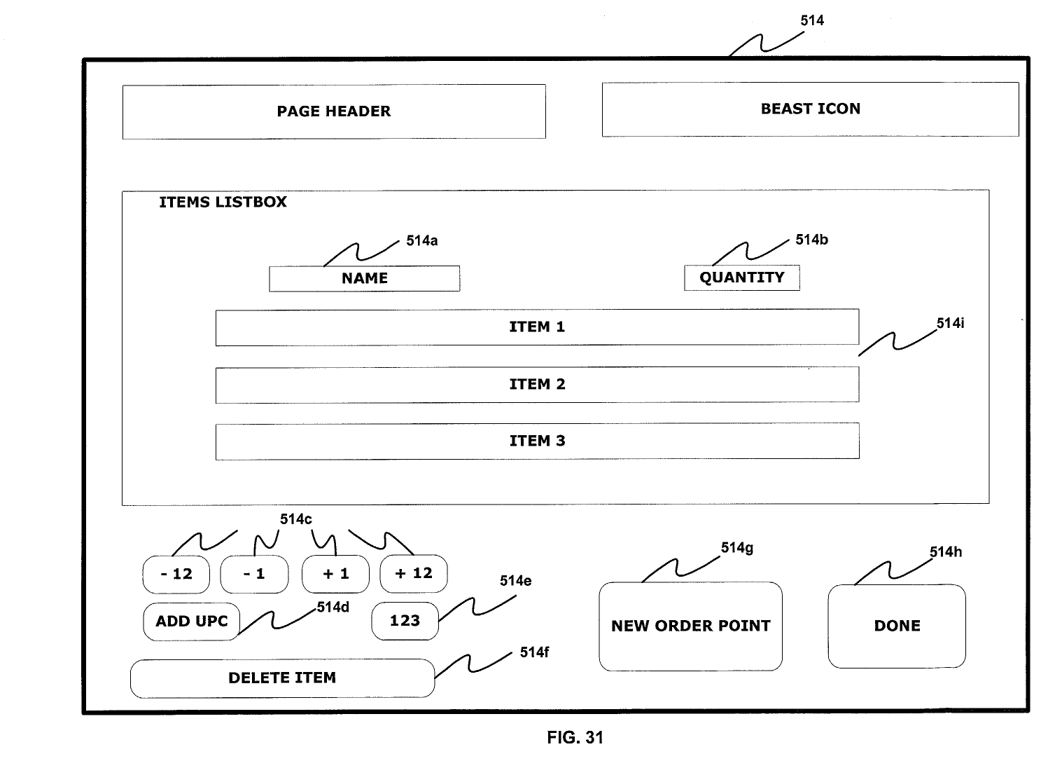

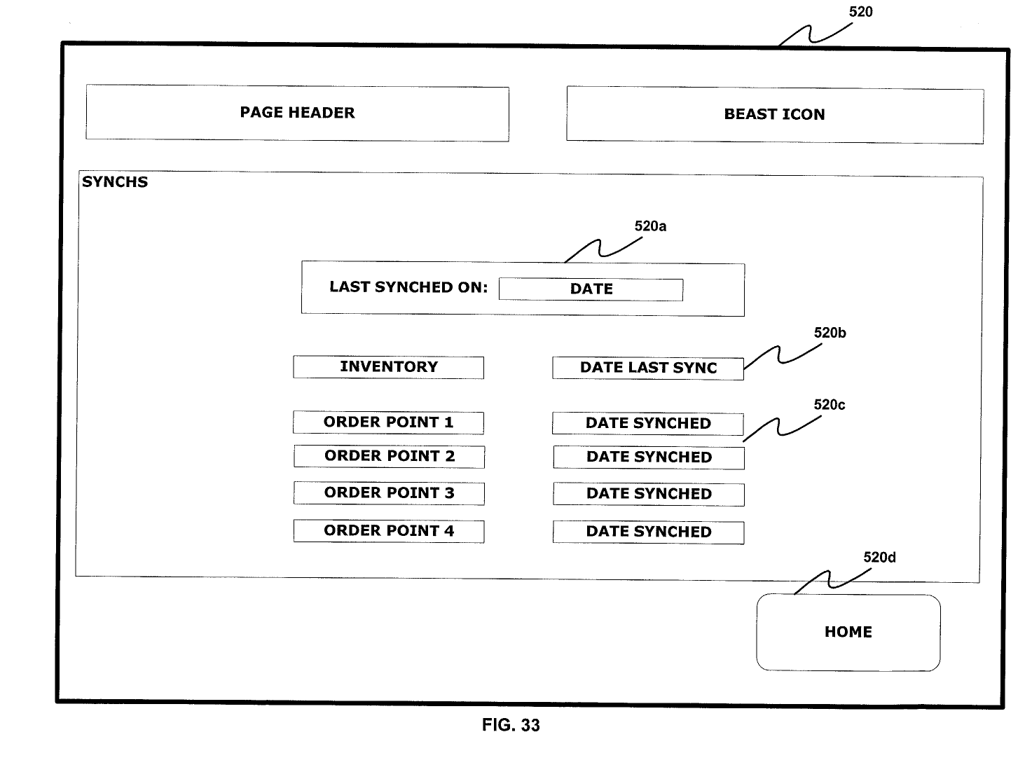

Referring to FIGS. 25 and 30-33, the user begins the breaksheet process with the Breaksheet Entry Point screen 512, which comprises a “Date” field 512a, an “Order Point” field 512b, a “Summary” field 512c, and a “Next” icon. As with the inventory data collection process, “Date” field 512a is preferably pre-populated with the current date, which may be modified by the user. The user makes sure that the date shown in the “Date” field 512a is the correct date, and selects in the “Order Point” field 512b an order point from which he will collect consumption data. Preferably, if the user selects an order point from which consumption data was not collected the previous day, the device will ask him whether he would like the information he is currently collecting to be averaged over the days missing consumption data or whether he would like the data he is gathering to be stored solely under the day he has selected. Upon making this decision, the user presses the “Next” icon 512d and is brought to the Breaksheet Scan screen 514 (see FIG. 31), where he may now collect consumption data. For every unit of product which has been consumed at the order point, the user either scans the empty product's UPC bar code or enters the UPC manually by pressing the “Add UPC” icon 514d and entering the UPC number. The user may continue to scan or manually enter the UPC for every occurrence of consumption of a product, or he may choose to count the number of units of a product that had been consumed and enter that number manually by selecting the “123” icon 514e. Preferably, when the UPC of a particular consumed unit of a product is scanned or manually entered only once and then the “123” icon is selected, and a number is entered, the device recognizes the number entered as the total number of consumed units for that product. If, however, the UPC of the consumed product is scanned or manually entered more than once, and a number is entered subsequently by selecting the “123” icon 514e, the device adds the number entered to the number of times the UPC has been scanned or manually entered. The device then records the sum of the two numbers as the total number of consumed units for the product. Alternatively, the user may scan or manually enter the UPC, and then add or subtract the number of consumed units by pressing one or more of the add/subtract icons 514c. For example, every time the “+1” icon is pressed, the device adds 1 to the number of consumed units recorded. Because beverages are often packaged in cases of 12, the “+12” icon can be used to add the number of cases of the consumed product to the total number of consumed units for that product. The icons “−1” and “−12” are used similarly for subtracting a single consumed unit or a case of 12 consumed units from the total number of consumed units. As the user collects consumption data, field 514i updates accordingly, with names of products appearing under the “Name” heading 514a and the number of consumed units for the products appearing under the “Quantity” heading 514b. Upon collecting the consumption data for the order point selected, the user may choose a new order point by pressing the “New Order Point” icon 514g and repeat the process until all consumed products have been collected from all order points at the venue. The user then chooses the “Done” icon 514h to communicate to the device that all of the consumption data have been collected.

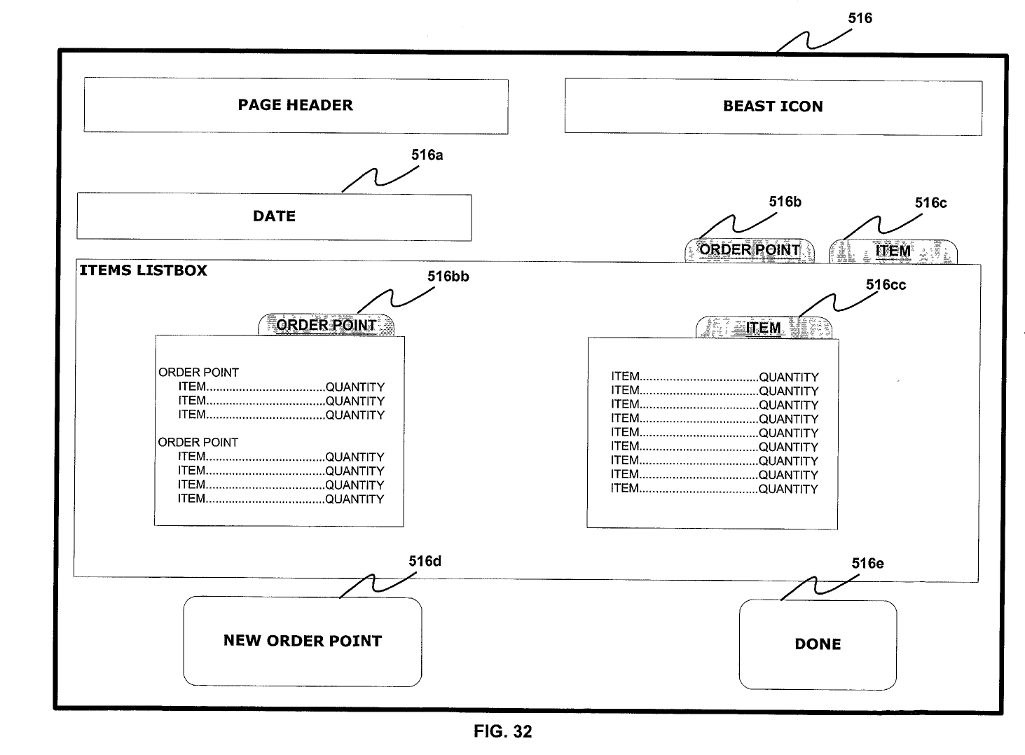

Turning specifically to FIGS. 25 and 32, the user is brought to the Breaksheet Summary screen 516 when the “Done” icon 514h is selected. Breaksheet Summary screen 516 includes a “Date” field 516a, an “Order Point” tab 516b, which brings the “Order Point” sub-screen 516bb to the foreground of the screen, an “Item” tab 516c, which brings the “Item” sub-screen 516cc to the screen foreground, a “New Order Point” icon 516d, and a “Done” icon 516e. Note that both sub-screens 516bb and 516cc are shown in the foreground in FIG. 32 for illustration only. Breaksheet Summary screen 516 provides a product consumption summary for a given date so that the user may confirm the consumption data he has collected for that date. The “Date” field 516a is preferably pre-populated with the current date, however, the user may change the date in the field to bring up the inventory summary for any particular date. The “Order Point” sub-screen 516bb provides a product consumption summary that is order-point specific. On the other hand, the “Item” sub-screen 516cc provides a product consumption summary for the whole entire venue. The user may go back to the Breaksheet Entry Point screen 512 to collect product consumption data for a new order point by selecting the “New Order Point” icon 516d. Similarly, at any time before, during or after the consumption data collection process, the user may go to the Breaksheet Summary screen 516 from the Breaksheet Entry Point screen 512 by selecting the “Summary” icon 512c and then the “Next” icon 512d. Upon confirming at the Breaksheet Summary screen 516 all the product consumption data collected, the user selects the “Done” icon 516e, which brings him to a Sync Reminder Page 522 (see FIG. 34). Sync Reminder Page 522 reminds the user to transfer the breaksheet data collected with the handheld device to the main system. Once the “OK” icon is selected, the user is brought back to Start Page 500, and he may then sync the handheld device with the main system. As mentioned above, the “Sync Indicator” 500d on the device Start Page 500 would flash to inform the user the availability of transferable data until that data have been transferred.

Turning now to FIGS. 25, 26 and 33, the user can check the data transfer (sync) history on the handheld device by pressing the “Sync Log” icon 500c on the device Start Page screen 500. The Sync History screen 520 provides the user the date of the last data transfer between the device and the inventory management system in “Date” field 520a, the last inventory data transfer in field 520b, and the last product consumption data transfer for a specific order point in field 520c. Preferably, the inventory data transfer history is venue specific. That is, it reflects the inventory data transfer history for the entire venue. However, the consumption data transfer history is preferably order-point specific. Therefore, field 520c preferably includes multiple dates, one corresponding to each order point. The user may go back to the device Start Page screen 500 from the Sync History screen 520 by selecting the “Home” icon 520d.

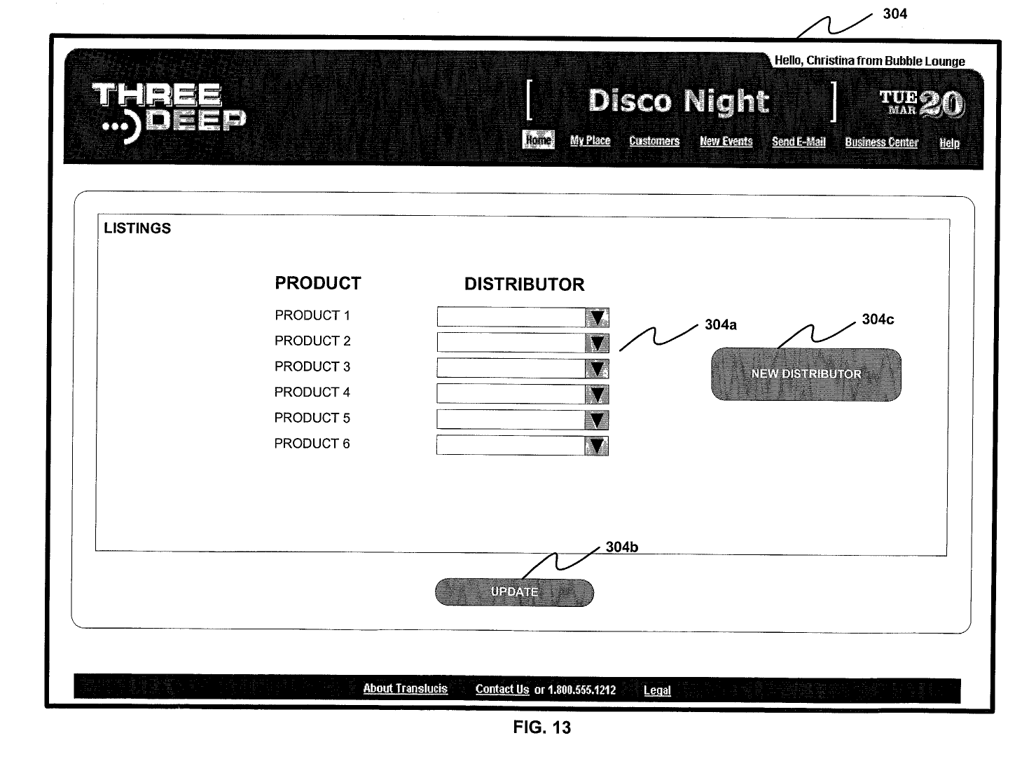

Referring to FIGS. 1 and 13, when the user re-enters the inventory management system as a member, the system checks its database for new products that may have been scanned by the user using the handheld device and registered in the system database (see decision block 302). If there are registered new products, the system brings the user to a Confirm Distributor page 304. Confirm Distributor page 304 includes a “Distributor” field 304a, which is preferably pre-populated with distributor names already entered and matched with specific products via Distributor Info page 208 and Match Distributors page 222, respectively. The system will offer a suggested distributor from the user's distributor list for the new product in the “Distributor” field 304a. If the user wishes to use the suggested distributor, he may select the “Update” icon 304b. Alternatively, the user may scroll down the list of distributors registered on the system by clicking on the down arrow in “Distributor” field 304a, and choose another distributor on the list. If, however, the user wishes to use a new distributor, he must select the “New Distributor” icon 304c, which will bring him to the Distributor Selection page 206 (see decision block 306).

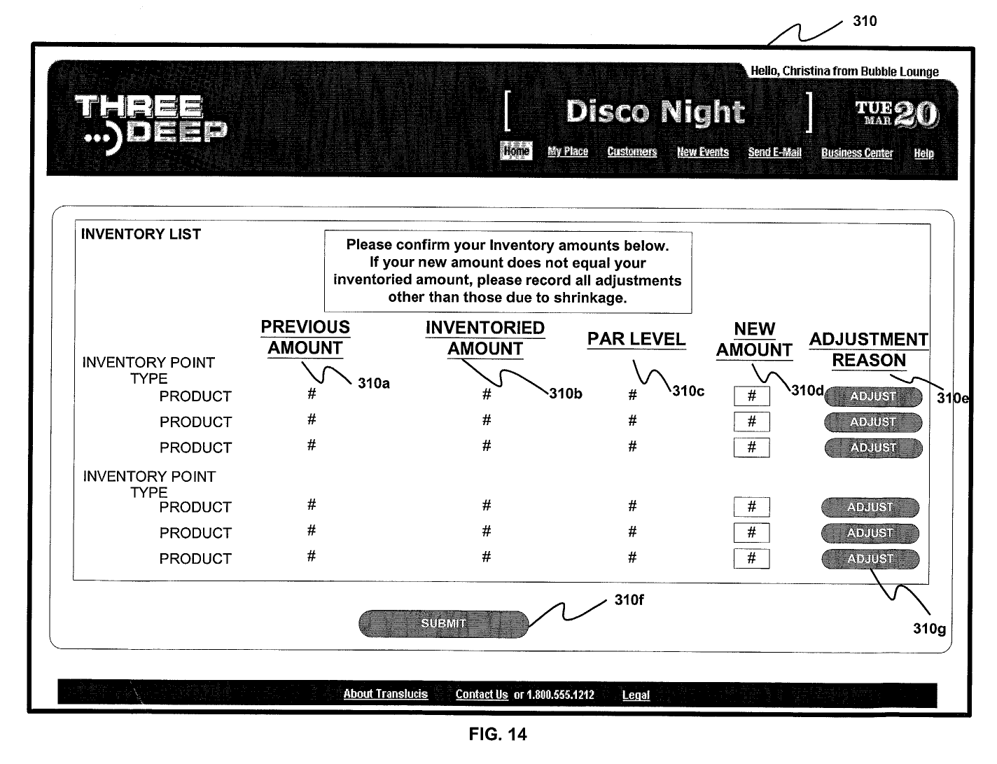

In addition to new products, the system also checks for unconfirmed new inventory data that may have been transferred to the system from the user's BeaST™ handheld or similar device. Turning to FIGS. 1 and 14, if such unconfirmed new inventory data are available in the system database, the system brings the user to a Confirm Inventory page 310. Confirm Inventory page 310 provides the last confirmed inventory data in a “Previous Amount” field 310a, the unconfirmed new data in a “Inventoried Amount” field 310b, and the par level registered on the system in a “Par Level” field 310c. Confirm Inventory page 310 also includes a “New Amount” field 310d, which is preferably pre-populated with the unconfirmed new inventory data. The user may change any unconfirmed new inventory data in the “New Amount” field 310d, along with the reason for the change in a “Adjustment Reason” field 310e. Preferably, the “Adjustment Reason” field 310e is pre-populated with a list of possible explanations for an inventory change so that the user may scroll down the list and choose the appropriate explanation for the inventory change. After entering the reason or reasons, the user selects an “Adjust” icon 310g to be brought to the Adjust Inventory page 312 in order to make the adjustment. The user is brought back to Confirm Inventory page 310 after the adjustment is entered. The user then selects the “Submit” icon 310f to confirm the new inventory data.

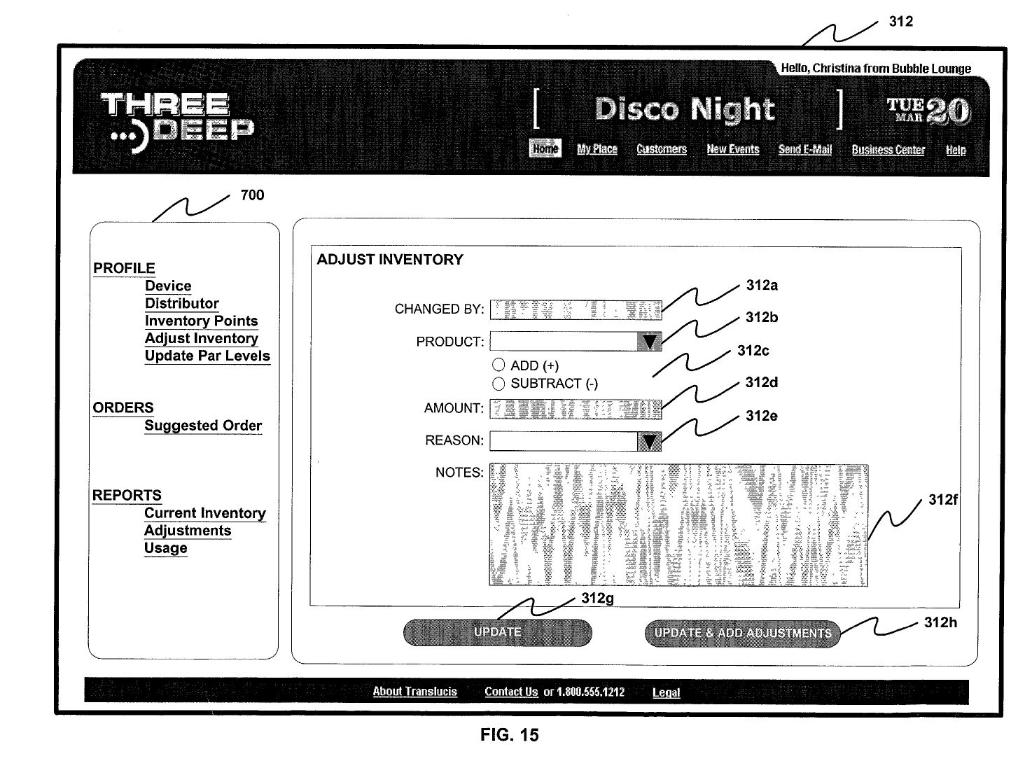

Referring to FIGS. 1, 4 and 15, the system brings the member-user to the Member page 108 after checking the availability of unconfirmed new products and new inventory data in the system database. The user may perform various tasks from the Member page 108. For example, the user may adjust his inventory level by choosing the “Adjust Inventory” label in “Profile” window 108a. This brings the user to Adjust Inventory page 312. To adjust inventory levels, the user first enters his name in a “Changed By:” window 312a. The user may then choose a product from the product list in “Product:” field 312b, select either “Add (+)” or “Subtract (−)” option 312c and enter an amount by which he wishes to add to or subtract from the existing inventory level in “Amount:” field 312d. In addition, the user has the option of selecting a reason for the adjustment from the “Reason:” field 312e, and making any personal notes in the “Notes:” field 312f. The user may then choose the “Update & Add Adjustments” icon 312h if he wishes to adjust the inventory level of another product. Otherwise, the user selects “Update” icon 312g to complete the adjustment.

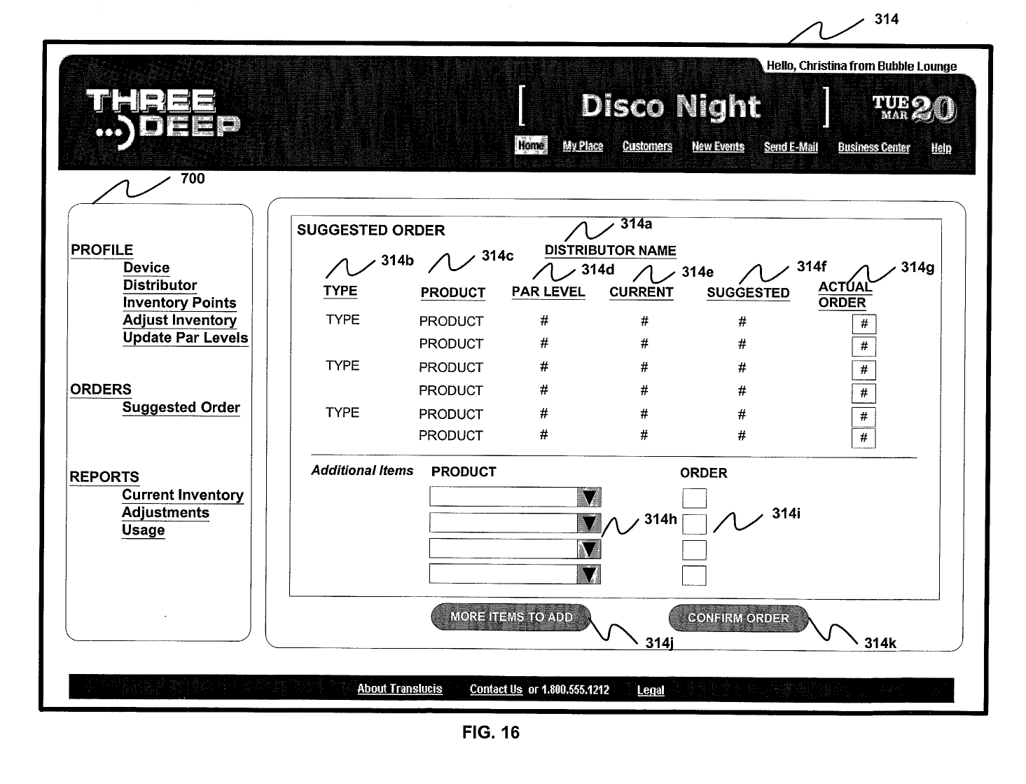

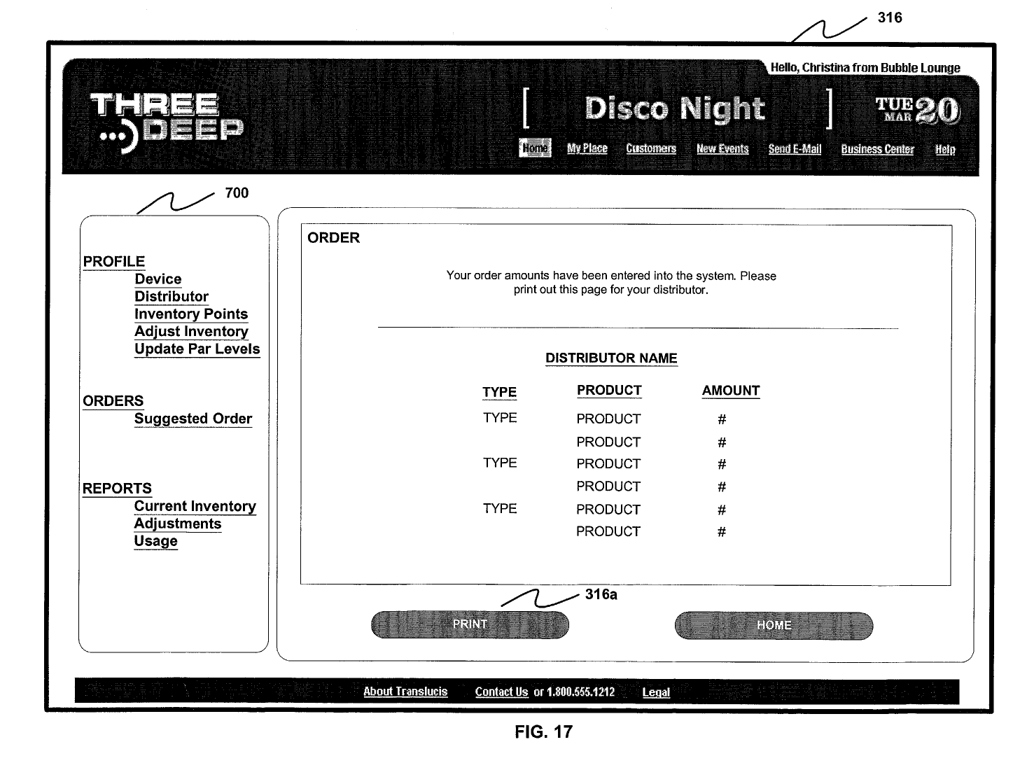

Referring now to FIGS. 1, 4, 16 and 17, the user can also view, modify, confirm and print suggested distributor orders from the Member page 108. To accomplish such tasks, the user first selects a particular distributor from the “Orders” window 108b, which brings the user to a Suggested Order page 314 (see FIG. 16). Basically, Suggested Order page 314 provides suggested orders for products with inventory levels under par. Specifically, Suggested Order page 314 shows the name of the distributor selected in “Distributor Name” field 314a, the type of products under par in “Type” field 314b, the product names in “Product” field 314c, the par level for each of the products in “Par Level in Storage” field 314d, the inventory level of the products in “Current Amount” field 314e, a suggested order for each of the products in “Suggested” field 314f, which is calculated by the system by subtracting the inventory level of a product from the par level of that product. In addition, Suggested Order page 314 also provides an “Actual Order” field 314g, which is pre-populated with the suggested orders. The user may either confirm the suggested orders as actual orders, or he may modify the pre-populated suggested orders in “Actual Order” field 314g to fit his need. Moreover, a second “Product” field 314h provides a scrollable list of products with inventory levels that are at par or exceeding par. The user may wish to order one or more of these products by entering the order in “Order” field 314i if, for example, there is a promotional sale for the product or products. Note that “Product” field 314h contains space for a limited number of products. Therefore, if the user wishes to place orders for more at-par or exceeding-par products, he may select the “More Item To Add” icon 314j, which enters his order for the products already selected in “Product” field 314h and provides blank windows for the user to enter order for more products. Upon completing the order information, the user selects “Confirm Order” field 314k, which brings the user to a Confirm Order page 316. The user may obtain a printout of his confirmed order by selecting the “Print” icon 316a. Alternatively, the user may request an electronic copy of a confirmed order to be sent to his e-mail address or a hard copy to be faxed to a facsimile number.

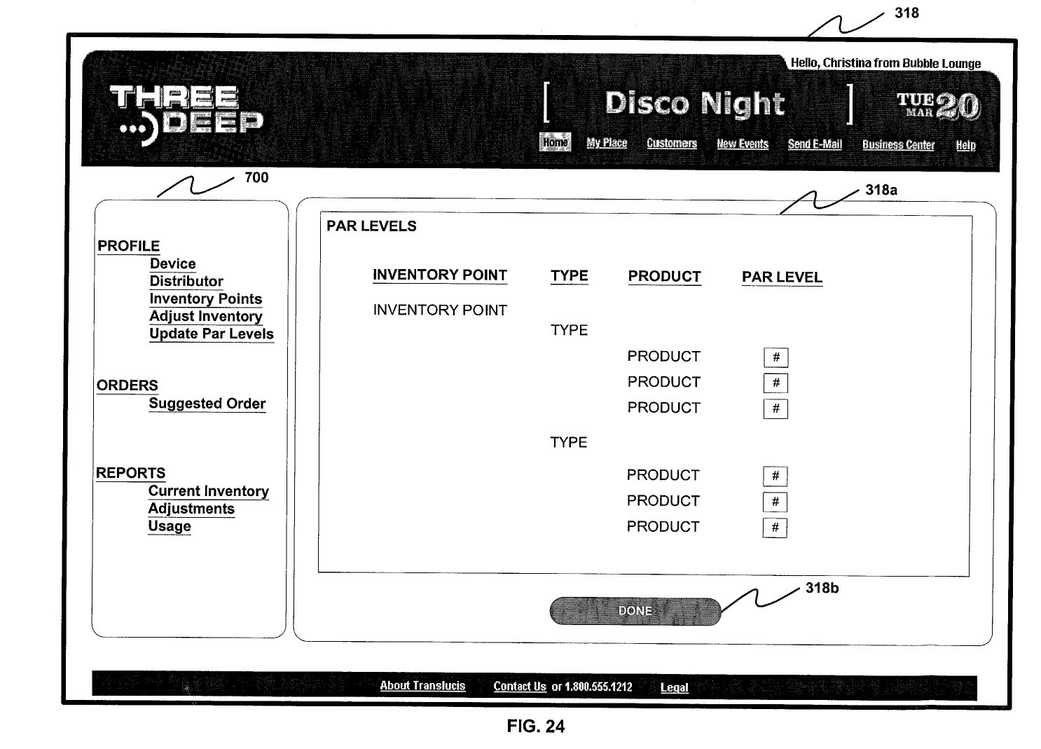

Turning to FIGS. 4 and 24, the user may update a par level for a product starting from the Member page 108. To accomplish such task, the user first selects the “Update Par Levels” label in “Profile” window 108a, which brings the user to a Update Par Levels page 318. The “Par Level” field 318a is preferably pre-populated with existing par levels stored in the system database. The user may modify the par levels by selecting the particular par level box and replacing the pre-populated number with a new par level number. The user selects “Done” icon 318b to update his par levels.

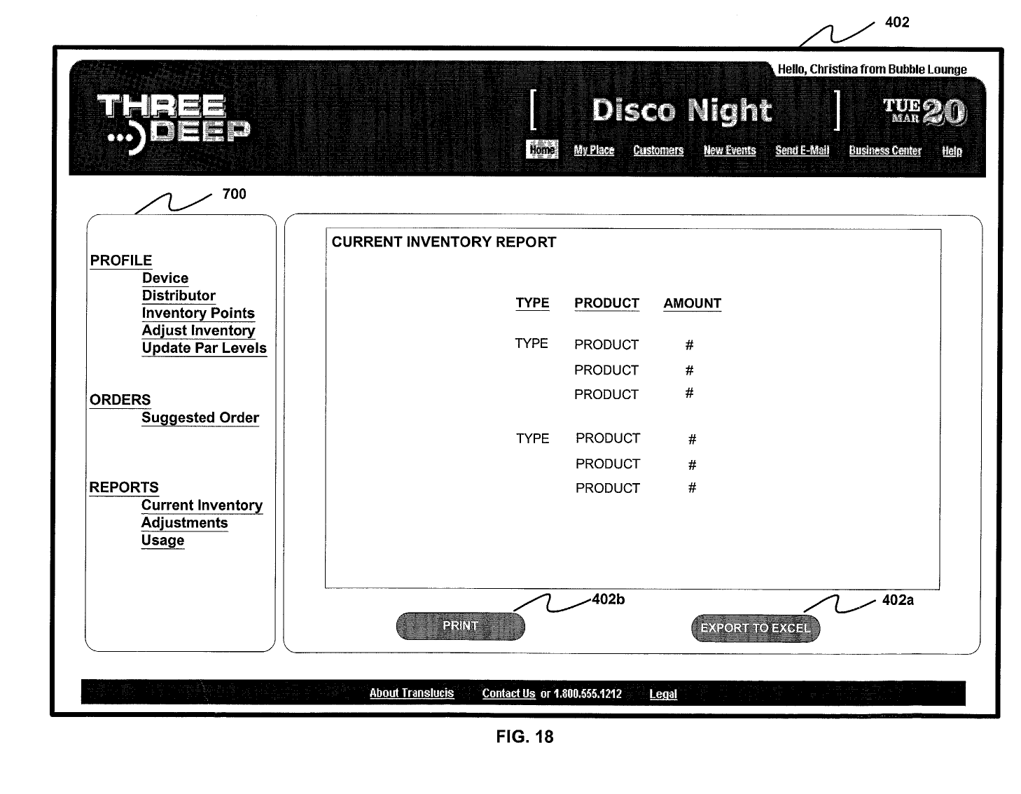

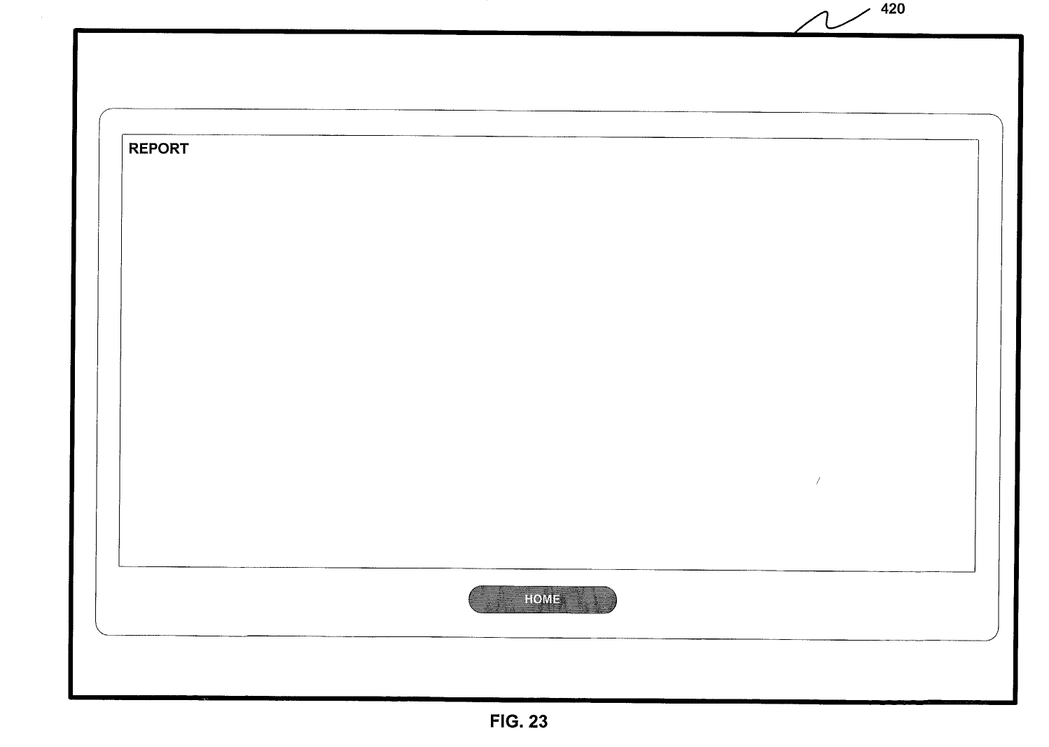

In addition, the user may utilize the reporting functions of the system from the Member page 108. Turning to FIGS. 4, 18 and 23, for example, the user may view and print an inventory report by selecting the “Current Inventory” label in the “Reports” window 108c , which will bring the user to C.I. Report page 402. C.I. Report page 402 shows a current inventory report outlining the types of products, the products, and the amount of inventory per product. The user may print this report with graphics by using the print command from his Internet browser. Alternatively, he may export the report to a spreadsheet software application such as Microsoft Excel or another similar program by selecting the “Export to Excel” icon 402a. Furthermore, the user may select the “Print” icon 402b to print the report in a printer-friendly, text-only format. This brings the user to the Print Report page 420, which shows the report in text-only format on screen. The user may then print the text-only report by using the print command of his Internet browser.

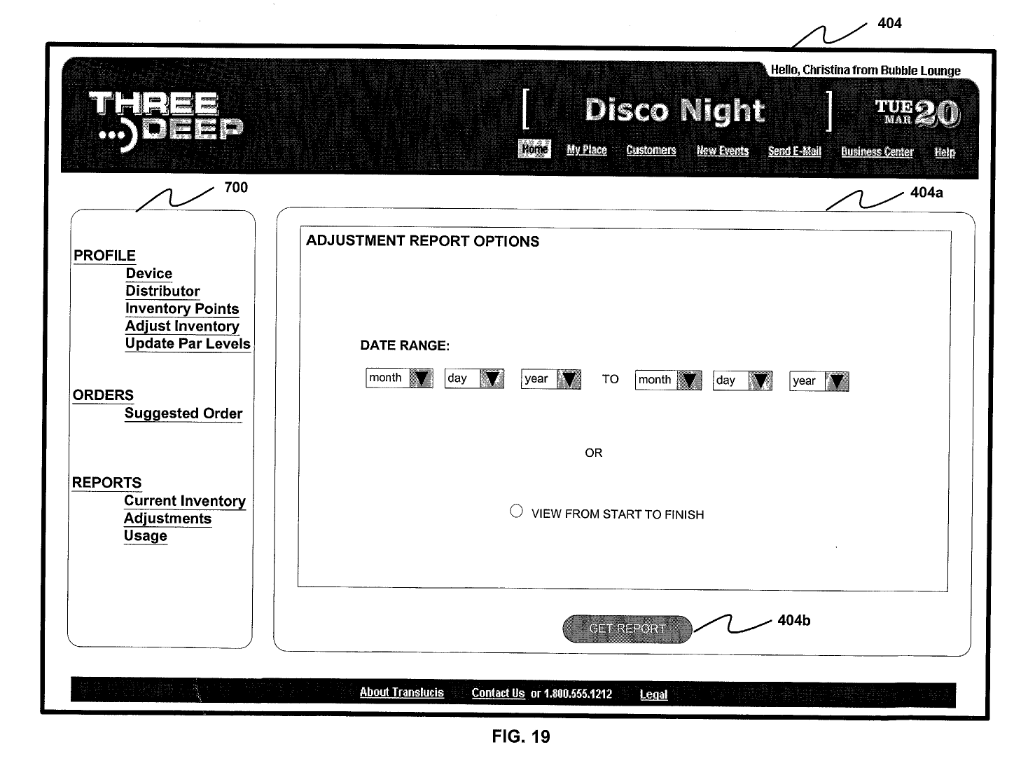

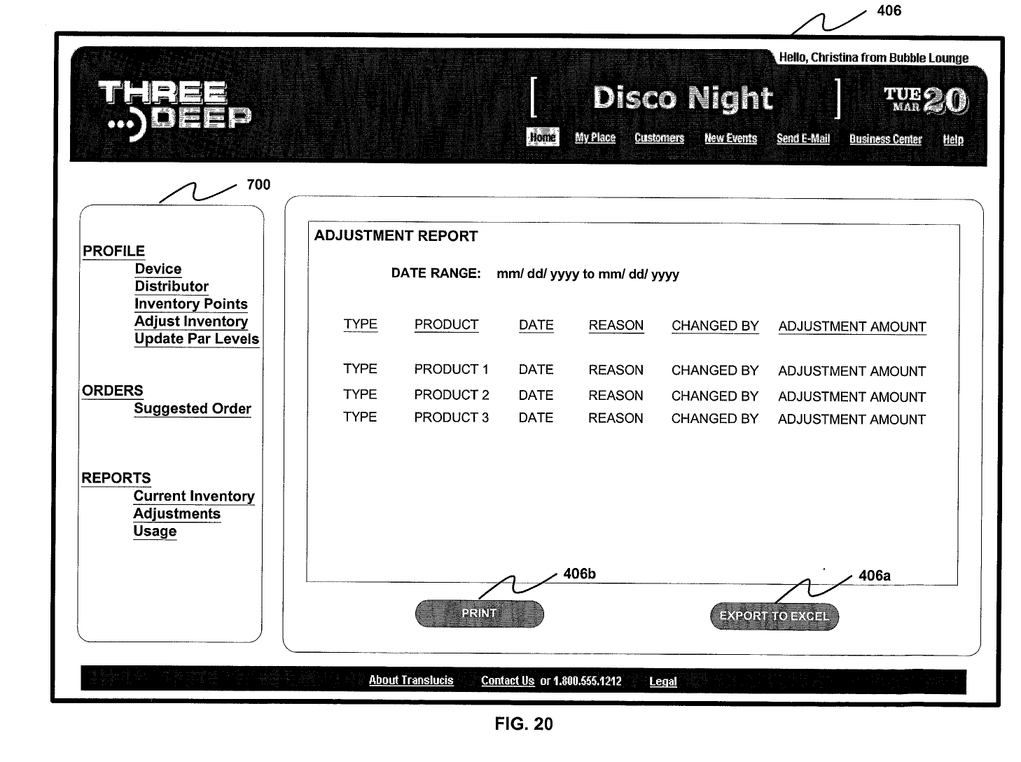

Similarly, referring to FIGS. 4, 19, 20 and 23, the user may view and print an adjustment report from the Member page 108 by selecting the “Adjustments” label in the “Reports” window 108c , which brings the user to Adjustments page 404. The user may specify a period of time for a report outlining all of the adjustments made during that period by entering the beginning and end dates of that period in window 404a. Alternatively, the user may wish to obtain a report for all of the adjustments since the date he started using the system by selecting the label “View from Start to Finish” in window 404a. The user then selects the “Get Report” icon 404b to go to the Adj. Report page 406. FIG. 20 illustrates a sample adjustment report in accordance with the principles of the present invention. Again, the user may print the report with original graphics by using the print command from his Internet browser, or he may export it to another software program such as Microsoft Excel by selecting the “Export to Excel” icon 406a. Alternatively, the user may print the report in a printer-friendly, text-only format by selecting the “Print” icon 406b, which brings the user to the Print Report page 420. The user may then print the text-only report by using the print command of his Internet browser.

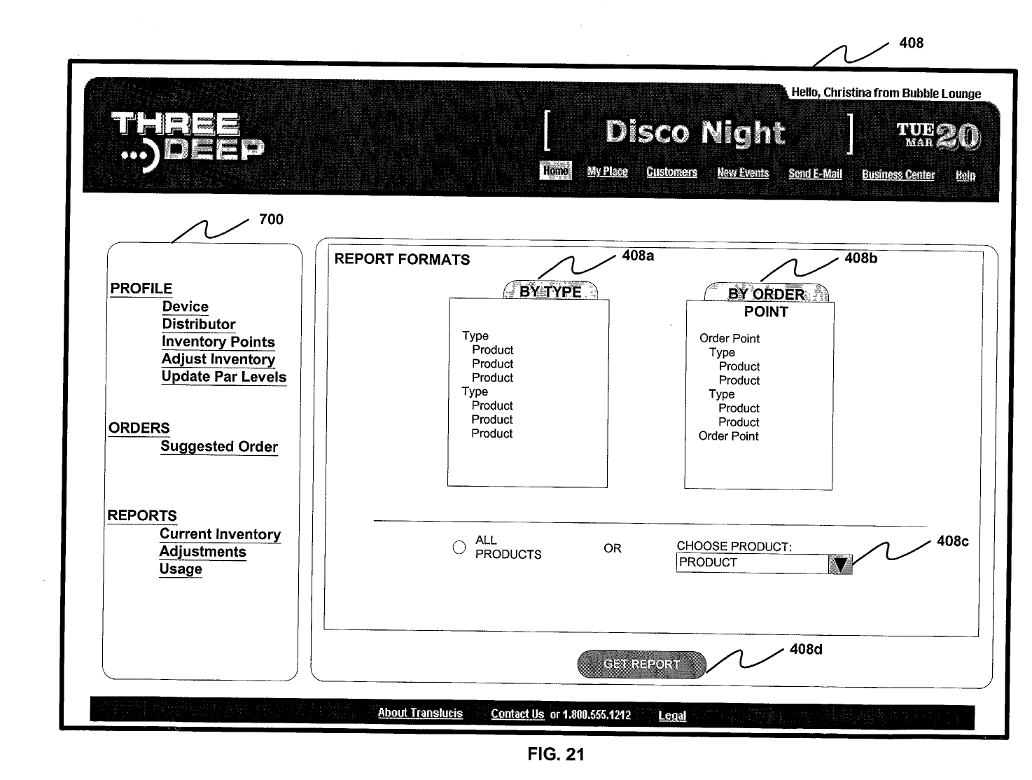

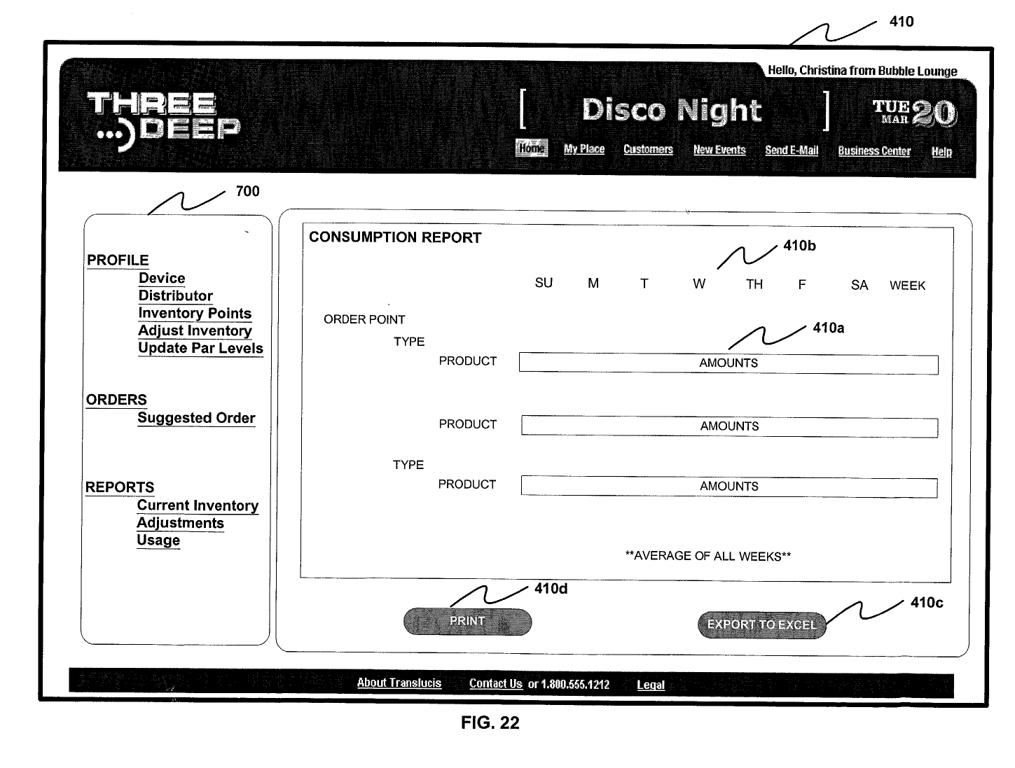

Referring now to FIGS. 4 and 21-23, the user may view and print a consumption report from the Member page 108 by selecting the “Usage” label in the “Reports” window 108c , which brings the user to Consumption page 408. Consumption page 408 enables the user to obtain the consumption report in two different formats: 1) by type or 2) by order point by selecting the “By Type” tab 408a or the “By Order Point” tab 408b, respectively. The user can also indicate whether he would want a consumption report for all products in his inventory or just a specific product by selecting accordingly in field 408c . The user then selects the “Get Report” icon 408d to go to the Consumption Report page 410. The Consumption Report page 410 provides a consumption report with average consumption amounts for each and every day of the week and on a weekly basis in “Amounts” field 410a under the “day of the week” heading 410b. Again, the user may print the report with original graphics by using the print command from his Internet browser, or he may export it to another software program such as Microsoft Excel by selecting the “Export to Excel” icon 410c. Alternatively, the user may print the report in a printer-friendly, text-only format by selecting the “Print” icon 410d, which brings the user to the Print Report page 420. The user may then print the text-only report by using the print command of his Internet browser.

Although the invention herein has been described with reference to particular embodiments, it is to be understood that the embodiments are merely illustrative of the principles and application of the present invention. It is therefore to be understood that various modifications may be made to the above mentioned embodiments and that other arrangements may be devised without departing from the spirit and scope of the present invention.

What is claimed is:

1. A method for tracking an inventory of at least one product having a plurality of product units, each product unit initially comprising a consumable portion inside a package having a machine-readable product code, an empty package remaining after consumption of the consumable portion, the method comprising reading the product code from each empty package with a machine.

2. The method of claim 1, further comprising reading the product code from each package prior to the consumption of the consumable portion, wherein an inventory amount for at least one product is calculated from the read product code of each package prior to the consumption of the consumable portion.

3. The method of claim 2, further comprising providing a suggested order amount for the inventory, wherein the suggested order amount is calculated by subtracting from a par amount the inventory amount.

4. The method of claim 3, wherein the suggested order amount is calculated by a remote server.

5. The method of claim 4, further comprising providing a database located in the remote server, wherein the product code read from each empty package and the product code read from each package prior to the consumption of the consumable portion are stored in the database.

6. The method of claim 5, further comprising generating a suggested distributor for each of the at least one product from the remote server.

7. A method for tracking an inventory of at least one consumable product having a plurality of product units, each product unit initially comprising a consumable portion inside a package having a machine-readable product code, an empty package remaining after consumption of the consumable portion, the method comprising the steps of:
reading the product code from each empty package with a machine;
storing the read product code as raw data; and
calculating a total number of consumed product units for each of the at least one consumable product.

8. A device for tracking an inventory of at least one consumable product having a plurality of product units, each product unit initially comprising a consumable portion inside a package having a machine-readable product code, an empty package remaining after consumption of the consumable portion, the device comprising a consumption data collection unit, wherein the product code of each empty package is read into the device and stored in the consumption data collection unit as consumption data.

9. The device of claim 8, further comprising a product code reader wherein the product code of each empty package is read into the device by using the product code reader.

10. The device of claim 9, further comprising an inventory data collection unit, wherein the product code from each package prior to the consumption of the consumable portion is read into the device by using the product code reader and stored in the inventory data collection unit as inventory data.

11. The device of claim 10, further comprising a data transfer unit, wherein the consumption data and inventory data are transferred to a database via the data transfer unit.

12. The device of claim 11, wherein the consumption data and inventory data are transferred to a database via an Internet connection.

13. The device of claim 12, wherein the data transferred to the database may be adjusted and more information may be input directly into the database.

14. The device of claim 13, wherein the data in the database may be transferred to the device via the data transfer unit.

15. A system for tracking an inventory of at least one consumable product having a plurality of product units, each product unit initially comprising a consumable portion inside a package having a machine-readable product code, an empty package remaining after consumption of the consumable portion, the system comprising:
a setup unit;
a tracking unit; and
a reporting unit,
wherein the setup unit creates an initial inventory profile, the tracking unit keeps track of consumed inventory, and the reporting unit generates an inventory report.

16. The system of claim 15, wherein the system is accessible via the Internet.

17. The system of claim 15, wherein the initial inventory profile comprises an initial inventory amount for each of the at least one consumable product.

18. The system of claim 15, wherein the consumed inventory is obtained by reading the product code of each empty package with a machine and transferring the product code from the machine to the system.

19. The system of claim 18, wherein the tracking unit comprises means for generating a suggested order amount for each of the at least one consumable product.

20. The system of claim 19, wherein the tracking unit further comprises means for generating a suggested distributor for each of the at least one consumable product.

21. The system of claim 20, wherein the tracking unit further comprises means for creating a new inventory profile.

22. The system of claim 21, wherein the tracking unit further comprises means for adjusting the new inventory profile.

23. The system of claim 22, wherein the tracking unit further comprises means for adjusting the consumed inventory.

24. The system of claim 15, wherein the inventory report is selected from the group consisting of a current inventory report, an inventory adjustment report and a product consumption report.

25. The system of claim 24, wherein the inventory report provides a summary based on a member selected from the group consisting of geography, product division, market division, venue, and venue groups.
